(19) United States
(12) Patent Application Publication
(10) Pub. No.: US 2016/0085430 A1
(43) Pub. Date: Mar. 24, 2016

(54) ADAPTING USER INTERFACE TO INTERACTION CRITERIA AND COMPONENT PROPERTIES

(71) Applicant: Microsoft Corporation, Redmond, WA (US)

(72) Inventors: Keri Kruse Moran, Bellevue, WA (US); William Scott Stauber, Seattle, WA (US); Petteri Mikkola, Bellevue, WA (US); Giorgio Francesco Sega, Kirkland, WA (US); Issa Y. Khoury, Redmond, WA (US); Mohammed Kaleemur Rahman, Seattle, WA (US); Kenton Allen Shipley, Woodinville, WA (US); Ramrajprabu Balasubramanian, Renton, WA (US); Ryan Chandler Pendlay, Bellevue, WA (US); Brian David Cross, Seattle, WA (US); Darren Ray Davis, Woodinville, WA (US); Elizabeth Fay Threlkeld, Redmond, WA (US); Patrick Derks, Seattle, WA (US)

(21) Appl. No.: 14/495,443

(22) Filed: Sep. 24, 2014

(51) Int. Cl. G06F 3/0484

(52) U.S. Cl. CPC G06F 3/04847; G06F 3/04842

(57) ABSTRACT

The manner of presenting a user interface of an application may be significant in many respects. A user interface may be suitable only for some devices (e.g., buttons may be selectable by a pointer, but not on a touch-sensitive display; textboxes may appear too large or too small on different displays), and may satisfy only some user interactions (e.g., a map interface may be usable on a laptop by a stationary user, but not usable in a vehicle while the user is driving). Presented herein are techniques for automatically generating a user interface that is adapted both for the interaction component properties of the device, and the interaction criteria of the user interaction with the user interface. A device may choose the presentation of each element of a user interface based on such information, and generate a user interface matching both the device and the user interaction with the application.

### BACKGROUND

Within the field of computing, many scenarios involve a presentation of a user interface of an application on a device to a user. The user interface may comprise, e.g., buttons, sliders, text areas, textboxes, lists, image boxes, and hypertext markup language (HTML) content areas. In order to facilitate developers and provide a consistent user experience, a device may provide applications with a stock set of user interface elements (e.g., a user interface control library, which developers may use to build a user interface for an application), and may assist applications in presenting such user interface elements in the user interface of the application.

A user may interact with the user interface on a particular device, such as a workstation, a large-screen home theater device, or a mobile device, such as a phone or tablet. To satisfy the various types of devices on which users may interact with an application, developers may choose to provide different versions of the user interface; e.g., a mobile version of an application or website may be provided for mobile devices featuring a small, touch-sensitive display, and a full version of the application may be provided for workstations featuring large displays and pointing devices. Additionally, the user interface may adapt to some properties of the device; e.g., the size of a textbox may adapt to the size of the enclosing window.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The large variety of devices and circumstances in which user interfaces are utilized presents a significant challenge for user interface development. As a first such example, developers may provide different versions of applications featuring different user interfaces that satisfy different devices; however, such developer-driven efforts may not adequately cover the vast and growing range of such devices, including the wide variance of input components (e.g., keyboards, mice, touchpads, touch-sensitive pointing, touch-based gestures, camera-based detection, voice input, gaze tracking, and input from other devices) and output components (e.g., displays of widely varying sizes, orientations, aspect ratios, resolutions, pixel densities, contrast and dynamic range, refresh rates, and visibility in sunlight), as well as other relevant resources (e.g., general and graphical processing capacity, and network capacity). As a second such example, different applications may be provided in view of different types of user interaction with the user. For example, a first mapping application may be designed and provided for the user interaction of trip planning; a second mapping application may be designed and provided for mobile users for the context of exploring an area on foot; and a third mapping application may be designed and provided for routing assistance for users driving a vehicle.

The large variety of such factors may pose a significant challenge to the developers of a user interface. As a first example, a developer may choose to create different versions of an application for different devices, but such circumstances may not cover some devices (e.g., no version of an application may be suitable for a device featuring a very large or very small display), and a particular may not adequately adapt to all such devices (e.g., the “mobile” version of an application may still appear too large or too small, in view of the large range of display sizes within the mobile space). As a second example, such user interfaces may not be capable of adapting to the circumstances of the user interaction (e.g., the device may be able to determine that a user interface element presents different types of content, or is used by the user in different circumstances, but may not be configured to adapt the user interface element based on these details). As a third such example, the user interaction with a user interface element may change (e.g., changes in the type of content presented by the user interface element, or in the user context of the user), but user interfaces may not be configured to adapt to such changes in the interaction criteria of the user interaction between the user and the application. For example, a “stock” textbox may be readily usable by users who are stationary and using a physical keyboard, but less usable by users who are walking and using an on-screen keyboard, and/or by users who are driving and communicating via a voice interface; and the user interface may neither be capable of adapting to any particular set of circumstances, nor adapting to changes in such circumstances as the user interacts with the user interface of the application.

Presented herein are techniques for configuring devices to adapt the elements of the user interface of an application based on both the properties of the interaction components of the device (e.g., input components, output components, processing components, and network capacity), and the interaction criteria of the user interaction of the user with the application (e.g., the content of the user interface element, the input precision providing an adequate interaction with the element of the user interface, and the context in which the user is likely to utilize the user interface).

In accordance with such techniques, a device may detect an interaction component property of the interaction component. The device may also, for respective user interface elements of the user interface of the application, identify an interaction criterion of a user interaction of the application with the user through the user interface element; and choose a presentation of the user interface element according to the interaction criterion of the user interaction, and the interaction component properties of the interaction components of the device. The device may then generate the user interface incorporating the presentation of the respective user interface elements, and present the user interface of the application to the user through the interaction component. In this manner, the device may enable the application to present a user interface with elements that are adapted to both the interaction component properties of the device and the interaction criteria of the user interaction between the user and the application, in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring a presentation of the user interface of an application on various devices featuring a variety of interaction components.

FIG. 2 is an illustration of an example scenario featuring a presentation of an application in multiple application variants respectively adapted for various device classes of devices.

FIG. 3 is an illustration of an exemplary scenario featuring a variety of factors that may affect the presentation of a user interface (e.g., various interaction component properties and various interaction criteria), and various presentations of a user interface element that may satisfy such factors, in accordance with the techniques presented herein.

FIG. 4 is an illustration of an example scenario featuring a presentation of the user interface of an application on various devices featuring a variety of interaction components, in accordance with the techniques presented herein.

FIG. 5 is a flow diagram of an example method of presenting a user interface on a device that is adapted to the interaction component properties of the interaction components of the device and the interaction criteria of the user interaction of the user with the application, in accordance with the techniques presented herein.

FIG. 6 is a component block diagram of an example system provided to present a user interface on a device that is adapted to the interaction component properties of the interaction components of the device and the interaction criteria of the user interaction of the user with the application, in accordance with the techniques presented herein.

FIG. 7 is an illustration of an example computer-readable medium comprising processor-executable instructions configured to embody one or more of the provisions set forth herein.

FIG. 8 is an illustration of an example scenario featuring a variety of interaction component properties of various interaction components that may inform the adaptation of a user interface of an application, in accordance with the techniques presented herein.

FIG. 9 is an illustration of an example scenario featuring a variety of interaction criteria of a user interaction between a user and an application that may inform the adaptation of a user interface of an application, in accordance with the techniques presented herein.

FIG. 10 is an illustration of an example scenario featuring a user interface presentation library providing various presentations of a user interface element that are respectively suitable for particular interaction component properties and interaction criteria, in accordance with the techniques presented herein.

FIG. 11 is an illustration of an example scenario featuring a selection of an interaction component for an interaction with an application, in accordance with the techniques presented herein.

FIG. 12 is an illustration of an example scenario featuring a selection of a presentation for a user interface element in view of a set of interaction component properties and interaction criteria, in accordance with the techniques presented herein.

FIG. 13 is an illustration of an example scenario featuring a composition of a user interface using different presentations selected from a user interface element presentation library, in accordance with the techniques presented herein.

FIG. 14 is an illustration of an example scenario featuring an adaptation of the presentation of an element of a user interface of an application according to updates in the interaction criteria of a user interaction of a user with an application, in accordance with the techniques presented herein.

FIG. 15 is an illustration of an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

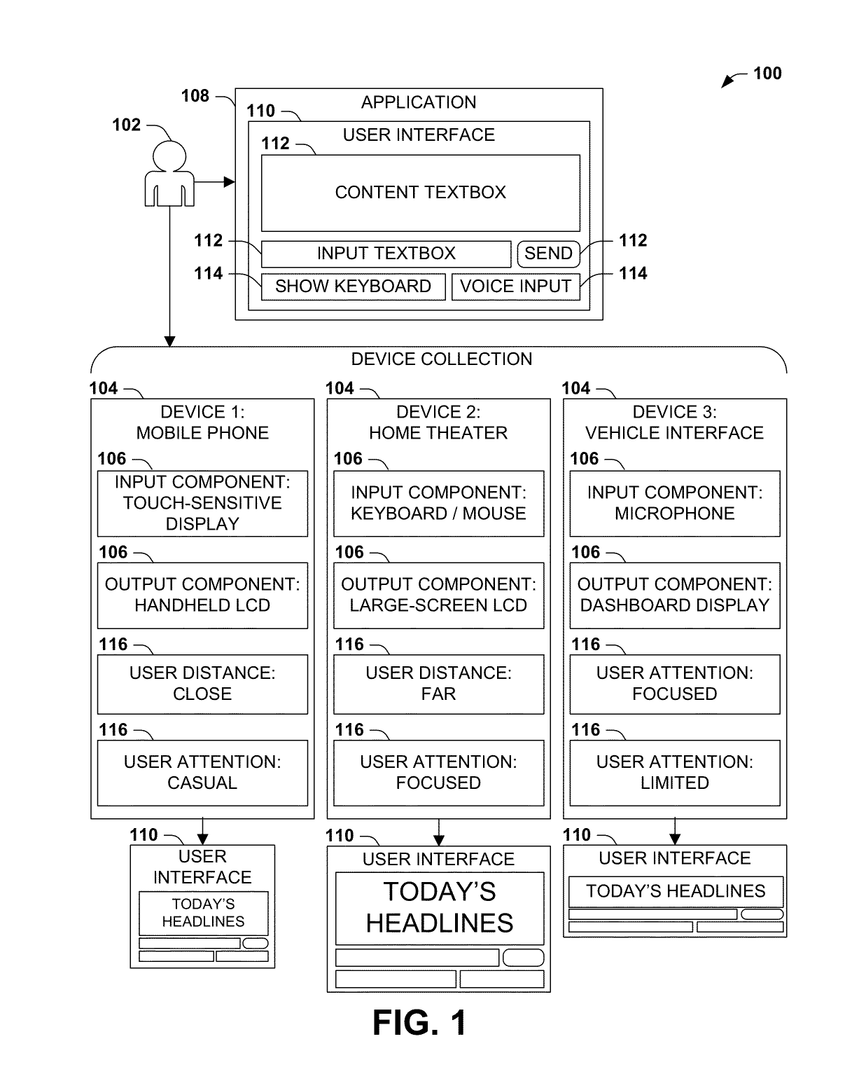

FIG. 1 presents an illustration of an example scenario 100 featuring an interaction of a user 102 with an application 108 featuring a user interface 110. In this example scenario, the user interface 110 features a collection of user interface elements 112, such as a first textbox that presents content; an input textbox that receives text input from the user 102; and a button that transmits the user input to a remote device or service. Such applications 108 may include, e.g., a web browser that accepts a uniform resource identifier (URI) of a web-accessible resource and presents the retrieved resource in the content textbox, or a messaging application that presents a dialogue of messages between the user 102 and a remote individual.

The user 102 may choose to use the application 108 through one of various types of device 104, which may features a variety of interaction components 106. As a first example, the device 104 may include an interaction component 106 comprising an input component, such as a keyboard, mouse, touchpad, touch-sensitive display, an orientation sensor, or a microphone that receives voice input. As a second example, the device 104 may include an interaction component 106 comprising an output component, such as a display, a set of speakers, or a vibration-producing motor. As a third example, the device 104 may utilize other resources in providing the user interface 110 to the user 102, such as a general-computation processor or a graphics coprocessor, or a network connection. Some user interfaces 110 may also allow a user 102 to access additional functionality. For example, an application 108 may typically receive user input through a physical keyboard, but may also provide a “show keyboard” option 114 that displays an on-screen keyboard through which the user 120 may enter text on a device 104 lacking a keyboard, and a “voice input” option 114 that receives input via the voice of the user 102 for voice-oriented device 104.

In order to facilitate the development of user-interface-based applications on a wide range of devices 104, a user interface framework may be provided that enables a software developer to design a user interface 110 as a collection of “stock” user interface elements 114. For example, a software platform may provide a basic implementation of clickable buttons; sliders; textboxes that accept text-based user input; content boxes that present content, such as hypertext markup language (HTML) content; and a map interface that displays a map of a particular location. The user interface framework may allow an application developer to select among many such user interface elements 112, and to specify particular properties of selected user interface elements 112, such as the size, shape, color, font, and behavior of the user interface element 112.

In order to present a user interface 110 on a particular device 104, the user interface framework may render the stock presentation of each user interface element 112 according to the properties selected by the application developer. Some aspects of the respective user interface elements 112 may also be adapted to the current presentation on the device 104. For example, the size of a user interface element 112 may be adapted to the size of a window on the display of the device 104, and colors of the user interface 110 and the font used to present text within a user interface element 112 may be selectable by the user 102. Moreover, in order to enable the application 108 to be presented through devices 104, the user interface framework may generate abstractions of various interaction components 106, and may consolidate the functionality of a wide range of interaction components 106 as a selected set of shared functions. For example, a mouse, a touchpad, a stylus, and a touch-sensitive display may exhibit significant operational differences, such as precision, speed, capabilities (such as the right-click ability of a mouse, and the capability of a “pinch” gesture on a touch-sensitive display), operating constraints (such as the edges of a touchpad or touch-sensitive display, and the surface positioning of a mouse), but the user interface framework may abstract these devices into a class of pointing devices that provide pointer movement, selection, dragging, and scrolling operations. In this manner, the user interface framework may adapt a wide range of input devices to a shared set of functionality in order to interact with the user interface 110 of an application 108.

In view of these variations, the presentation of a particular user interface 110 of an application 108 may be adapted for a wide range of devices 104. However, limitations in such adaptive user interface models may render user interfaces 110 suitable for a first set of devices 104, less suitable for a second set of devices 104, and unsuitable for a third set of devices 104. For example, the scalability of the user interface 110 of an application 108 based upon the size of the display of a device 104 may be suitable for a selected range of displays, but such adaptability may fail to account for the large variety of displays upon which the user 102 may view the user interface 110. For example, the sizes and arrangement of user interface elements 112 of a user interface 110 may look fine on a first device 104, such as a workstation with a display featuring a typical size, resolution, and pixel density. However, when presented on a second device 104 featuring a small display, such as a mobile phone, the user interface elements 112 may appear too small to be selected, and content presented therein may be illegible. When presented on a third device 104 featuring a large display, such as a home theater display or a projector, the user interface elements 112 may appear overly and perhaps comically large, such as an oversized button and very large text that unnecessarily limits the amount of content presentable within a content box. When presented on a fourth device 104 featuring an unusually shaped display, such as a vehicle computer that is embedded in a dashboard and features a very wide but not very tall display, the user interface elements 112 may be rendered in an unappealing and unsuitable manner, such as stretching textboxes and buttons to a large width and compressing to a small height.

Additional limitations may arise from the abstraction of interaction components 106 to a shared set of basic functionality. For example, a user interface element 112 such as a scrollable list may be readily usable by elements with suitable scrolling capabilities, such as a mouse featuring a scroll wheel. However, other interaction components 106 may exhibit functionality that enables scrolling, but only over short distances (e.g., a scroll gesture provided on a touch-sensitive display may be limited by the edges of the display), but scrolling through a lengthy list may be tedious; and other interaction components 106 may enable scrolling in a fast or extensive manner, but may not provide a high level of precision (e.g., the discrete steps of a mouse scroll wheel may be too large to enable fine scrolling). Still other interaction components 106 that are grouped into an abstract class of devices may be unsuitable for a particular type of functionality; e.g., a single-point touchpad may not be capable of detecting any gesture that may be interpreted as a “right-click” action.

Moreover, a user 102 may interact with an application 108 differently through different types of devices. For example, the user 102 may utilize a workstation or laptop; a mobile device, such as a phone or tablet; a home theater device, such as a smart television or a game console attached to a projector; a wearable device, such as a computer embedded in a wristwatch, earpiece, or eyewear; or a vehicle interface, such as a computer mounted in an automobile dashboard or console. The various types of devices 104 may be suited to different types of user interaction between the user 102 and the application 108, such that the interaction criteria 116 describing each such user interaction may vary. As a first example of an interaction criterion 116, the physical distance between the user 102 and the device 104 may vary; e.g., the user 102 may interact with a phone or wristwatch at a distance of a half-meter; may interact with a display of a workstation device at a distance of one meter; and may interact with a home theater display or projector at a distance of many meters. As a second example of an interaction criterion 116, the user 102 may interact with various devices 104 and applications 108 using a particular level of attention, such as a high level of attention when interacting with a complex design application 108; a medium level of attention when interacting with an application 108 in a casual context, such as a background media player or a social media application; and a low level of attention when interacting with an application 108 while operating a vehicle.

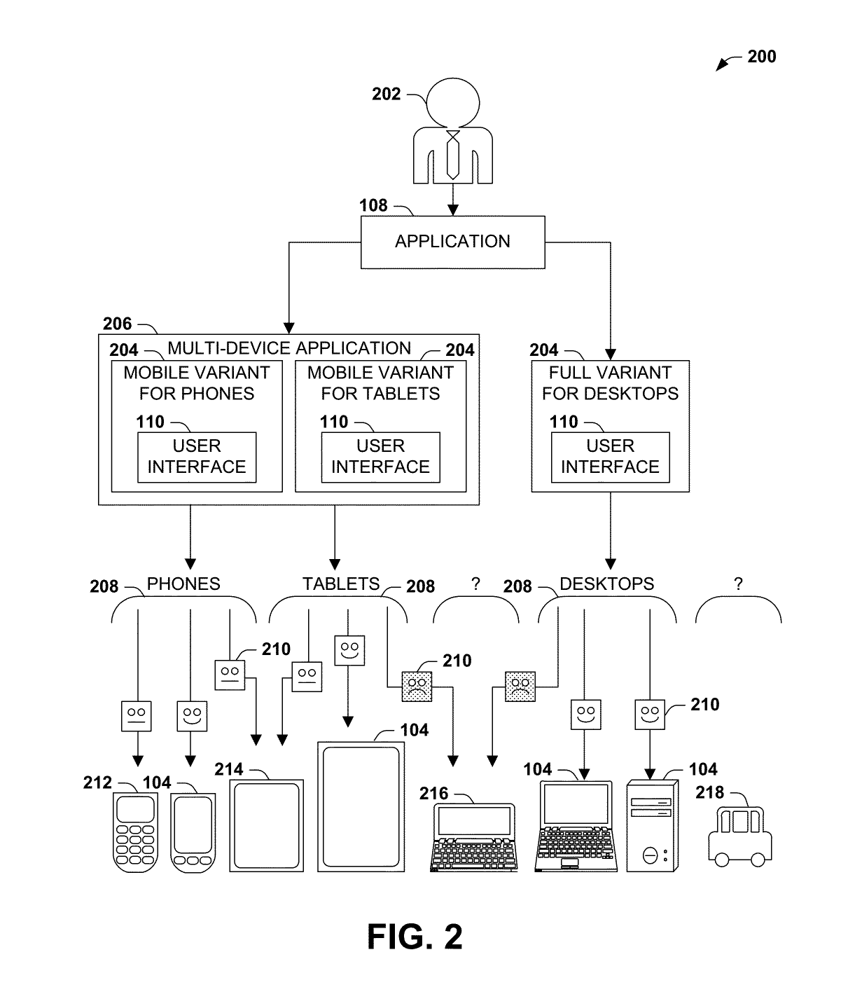

Various techniques maybe utilized to satisfy the large and diverse range of devices 104 and interaction criteria 116 in which a user 102 may engage an application 108. FIG. 2 presents an illustration of an example scenario 200 featuring one such technique, wherein an application developer 202 of an application 108 provides a variety of application variants 204, each adapted to a particular 208 class of devices 104. For example, the application developer 202 may develop a first application variant 204 featuring a user interface 110 adapted to phone form-factor devices 104; a second application variant 204 featuring a user interface 110 adapted to tablet form-factor devices 104; and a third application variant 204 featuring a user interface 110 adapted to desktop and laptop form-factor devices 110. Respective devices 104 may retrieve an application variant 204 for the class 208 of form factors of the device 104, and may present the user interface 110 adapted therefor. In some cases, a single application 108 may also be designed to suit a set of form factors, such as a multi-device application 206 that presents different user interfaces 110 on different classes 208 of devices 104, and/or allows a user 102 to select among several user interfaces 110 to find one that is suitable for the device 104.

However, the efforts of an application developer 202 to provide a multitude of application variants 204 and user interfaces 110 for various devices 104 and interaction criteria 116 may be inadequate in several respects. As a first example, such efforts involve redundant effort by the application developer 202, particularly as further development of the application 108 may entail individual maintenance and attention to each of several application variants 204. Such effort may scale to unsustainable levels as the number and sophistication of such user interfaces 110 grows. As a second example, undesirable discrepancies and divergence may arise among different user interfaces 110 of the same application 108, such as differences in appearance, behavior, or functionality of different user interfaces 110 that may be confusing to the user 102. As a third example, the provision of a user interface 110 for a particular class 208 of devices 104 may not even adequately suit all of the device 104 within the defined class 208. As a first such example, the “phone” application variant 204 may present a good user experience 210 on a first phone device 104, but only a mediocre user experience 210 on a second phone device 104 that has more limited resources. As a second such example, a particular device 214 with interaction component properties 106 exhibiting characteristics that fall between two or more classes 208 (e.g., “phablet” devices, which are larger than a typical mobile phone but smaller than a full-fledged tablet) may not be well-adapted for the user interface 110 of either application variant 204, and may present only a mediocre user experience 210 through either application variant 204. As a third such example, a particular device 216 may exhibit unusual device characteristics, such as an unusual aspect ratio, which may not be well-adapted for any of the application variants 204, and may therefore present a poor user experience 210 through any such application variant 204. As a fourth such example, a fourth device 218 may be architecturally capable of executing the application 108, but may not fit within any of the classes 208 of devices 104, and may be completely incapable of presenting any of the user interfaces 110 in a suitable way.

As a still further limitation, devices 104 may have access to a rich set of information about the interaction criteria 116 of the user interaction of the user 102 with the application 108, but the user interface elements 112 of the user interface 110 may not adapt to such interaction criteria 116. As a first such example, a device 104 may be able to detect that the user 102 is interacting with an application 108 in a particular context, such as while sitting, walking, running, driving a vehicle, but the user interface elements 112 may not automatically adapt to such scenarios in any way. The application 108 may simply provide options to the user 102 to customize the application 108, such as activating a “do not disturb” mode or toggling between an audio interface and a visual interface, but adaptations that are driven by the user 102 may frustrate the user 102 (e.g., the user 102 may have to select the “voice input” 114 repeatedly to interact with the device 104 while in an audio-only context). As a second such example, the device 104 may be able to detect that a user interface element 112 is providing a particular type of content, such as a text interface that presents a small amount of text, a large amount of text, a static image, a video, or an interactive interface, but may not adapt the user interface element 112 according to the presented content, unless specifically configured to adapt in such a manner by the application developer. As a third such example, the interaction criteria 116 of the user interaction between the user 102 and the application 108 may change over time (e.g., the user 102 may transfer the application 108 from a first device 104 to a second device 104, or may use the same device 104 in different contexts, such as while stationary, while walking, and while driving), but the application 108 may not respond to such changes in the interaction criteria 116. These and other limitations may arise from user interface frameworks and design models where the adaptation of user interface elements 112 to the various device types, interaction component properties of various interaction components 106 of the device 104, and the various interaction criteria 116, are achievable only through the efforts of the application developer and/or the user 102.

### B. Presented Techniques

Presented herein are techniques for presenting a user interface 110 that automatically adapts to both the device 104 and the user interaction between the user 102 and the application 110. In accordance with such techniques, a device 104 may detect an interaction component property of an interaction component 106 through which the user interface 110 is presented. The device 102 may also, for the respective user interface elements 112 of the user interface 110 of the application 108, identify an interaction criterion of a user interaction of the application 108 with the user 102 through the user interface element 112. Using such information, the device 104 may choose a presentation of the respective user interface elements 114 according to the interaction criterion of the user interaction, and the interaction component properties of the interaction components 106. The device 104 may then generate the user interface 110 by incorporating the presentation of the respective user interface elements 112, and may present the user interface 110 of the application 108 to the user 102 through the interaction components 106 of the device 104, in accordance with the techniques presented herein.

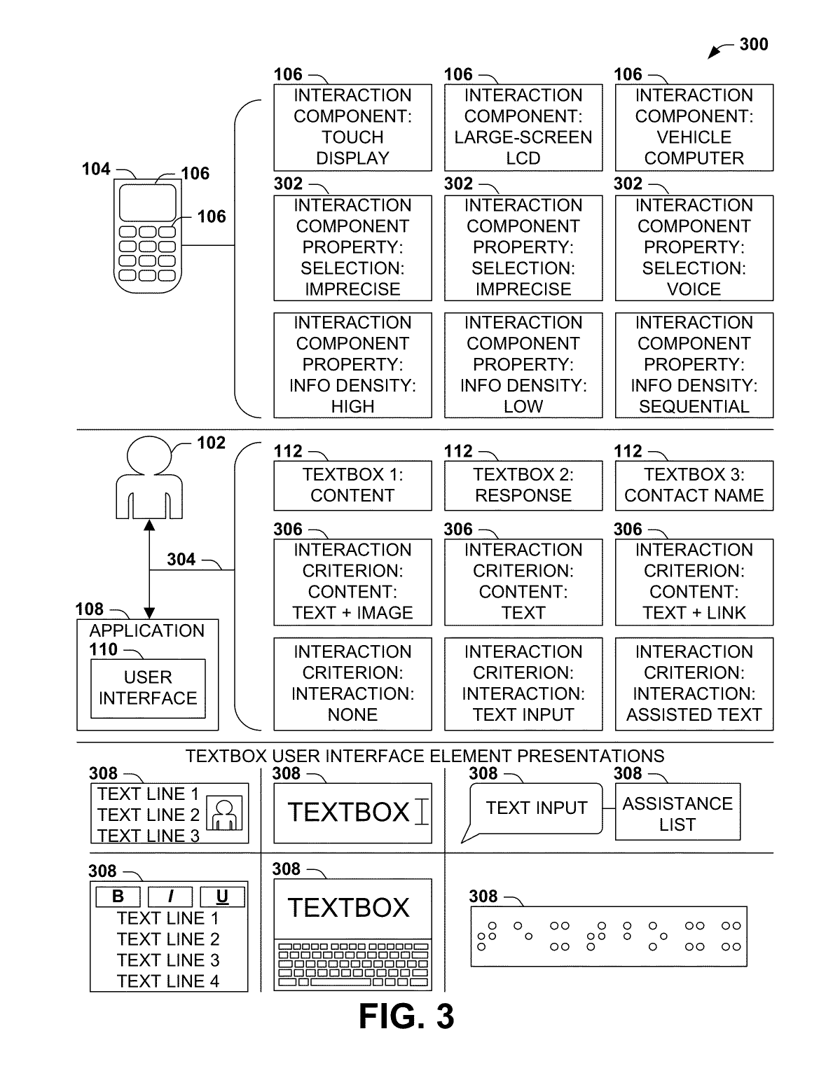

FIG. 3 presents an illustration of an example scenario 300 featuring some variable aspects that may be utilized in the adaptation of a user interface 110 of an application 108 in accordance with the techniques presented herein. In this example scenario 300, a device 104 may present a set of interaction components 106, such as a touch-sensitive or touch-insensitive display, a numeric keypad, a physical keyboard, a mouse, and an orientation sensor. In contrast with consolidating the functionality of the interaction components 106 into a shared set of base functionality, such as pointer movement, clicking, and dragging, the interaction component properties 302 of the respective interaction components 106 may be considered. As a first such example, the interaction component properties 302 of a touch-sensitive display may include the imprecise selection of user interface elements 112 using a fingertip of the user 102, and the high information density of the display (e.g., maximizing the display space of the device 104, due to the comparatively small display size). As a second such example, the interaction component properties 302 of a large-screen display may also include an imprecise input component, due to the comparatively large display space around which the user 102 may navigate, but a comparatively low information density, since presenting user interface elements 112 in close proximity may appear cluttered and overwhelming on a large display. As a third such example, the interaction component properties 302 of a vehicle computer may include a reliance upon voice as an input modality, and the presentation of information as a stream of spoken output, such as audio alerts and the utilization of text-to-voice translation to present an audio format of text information.

As further illustrated in the example scenario 300 of FIG. 3, the user interaction 304 of the user 102 with the user interface 110 of the application 108 may also be evaluated. For example, the application 108 may provide a user interface 110 comprising user interface elements 112, each comprising a textbox. However, the textboxes may be used in the user interface 110 of the application 108 in different ways. As a first such example, a first user interface element 112 may comprise a textbox that presents a broad set of content, such as text and images, but that does not permit user interaction. A second user interface element 112 may comprise a textbox that accepts a text response from the user 102, such as a message to convey messages, where the input from the user 102 is text-based and the output from other individuals is also text-based. A third user interface element 112 may comprise a contact name textbox, which not only presents text and a link to a social network profile of the contact, but also communicates with the user 102 through an assistive textbox that attempts to assist the user, e.g., by providing automatic completion of partially entered words.

As further illustrated in the example scenario 300 of FIG. 3, the device 104 may comprise a set of user interface element presentations 308, each expressing a particular user interface element 112 with particular features. For example, a first textbox presentation 308 may enable a rich set of readable text and images. A second textbox presentation 308 may allow simple text entry. A third textbox presentation 308 may enable rich text editing, such as document formatting and font selection. A fourth textbox presentation 308 may incorporate an on-screen keyboard to facilitate text entry. A fifth textbox presentation 308 may receive voice input and translate it into text input, with an assistance list of terms that the textbox is capable of recommending to the user 102 to correct spelling errors and/or facilitate input. A sixth textbox presentation 308 may provide user output through a specialized output component, such braille tactile output device.

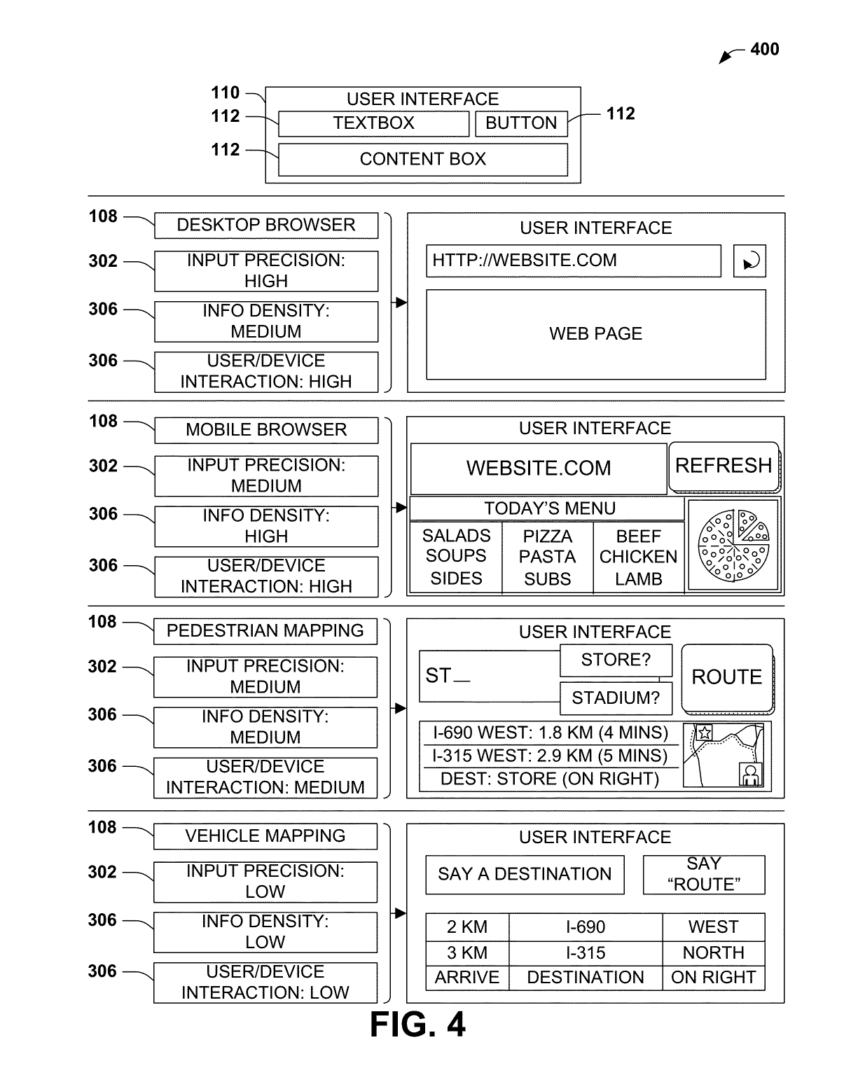

FIG. 4 presents an illustration of an example scenario 400 featuring the provision of user interfaces 110 for various applications 108 that adapt the user interface elements 112 to such aspects, in view of the variable aspects illustrated in the example scenario 300 of FIG. 3. In this example scenario 400, various applications 108 (such as a desktop browser, a mobile browser, a pedestrian-oriented mapping application, and a vehicle-oriented mapping application) may each utilize a user interface 110 featuring a collection of three user interface elements 112: a textbox, a button, and content box. However, the respective applications 108 may each be executed on a different type of device 104 featuring a particular set of interaction components 106, and may be suited for a particular type of user interaction 304 between the user 102 and the application 108. According to the techniques presented herein, the user interface 110 of each application 108 may be automatically generated and provided to the user 102 by selecting a presentation 308 of each user interface element 112 according to both the interaction component properties 302 of the interaction components 106 of the device, and the interaction criteria 306 of the user interaction 304 between the user 102 and the application 108.

As a first example, a desktop browser application 108 may be used on a desktop device featuring an input device, such as a mouse, that exhibits high-precision input as an interaction component property 302. Additionally, the desktop browser may be used in a user interaction 304 that typically involves a medium view distance (e.g., approximately one meter), and the user interface 110 may therefore be arranged according to an interaction criterion 306 exhibiting a medium information density (e.g., neither crowding the user interface elements 112 together, nor sparsely distributing such user interface elements 112). Additionally, the user interaction 304 between the user 102 and the desktop browser application 108 may typically exhibit an interface criterion 306 indicating a high degree of user interaction (e.g., in a desktop environment, the user 102 may be interested in focusing closely on the user interaction 304 with the desktop browser application 108). The resulting user interface 110 may therefore select and arrange presentations 308 of the respective user interface elements 112 that satisfy these interaction component properties 302 and interaction criteria 306, such as a typical density of arranged user interface elements 112, each exhibiting a presentation 308 that reflects the high input precision and interaction of a desktop environment.

As a second example, a mobile browser application 108 may be used on a mobile device featuring an input device, such as a capacitative touch interface, that exhibits only a medium level of precision as an interaction component property 302. Additionally, the mobile browser may be used in a user interaction 304 that typically involves a close view distance (e.g., through a handheld device), and the user interface 110 may therefore be arranged according to an interaction criterion 306 exhibiting a high information density (e.g., condensing the user interface elements 112 to maximize the display space of the mobile device 104). Additionally, the user interaction 304 between the user 102 and the mobile browser application 108 may typically exhibit an interface criterion 306 indicating a high degree of user interaction (e.g., although used in a mobile context, the user 102 may still be interested in focusing closely on the user interaction 304 with the mobile browser application 108). The resulting user interface 110 may therefore select and arrange presentations 308 of the respective user interface elements 112 that satisfy these interaction component properties 302 and interaction criteria 306, such as a condensed set of user interface elements 112, and where interactive user interface elements 112 are oversized for easy selection through low-precision input.

As a third example, a pedestrian-oriented mapping application 108 may also be used on a mobile device featuring an input device, such as a capacitative touch interface; however, if the user 102 utilizes the application 108 frequently while standing or walking, the user's input through the interaction component 106 may exhibit interaction component property 302 may exhibit a low degree of precision. Additionally, the pedestrian mapping may be used in a user interaction 304 that typically involves, as an interaction criterion 306, a medium information density (e.g., presenting detail in a large manner such that a user 102 who is walking is able to view it); and the user interaction 304 between the user 102 and the pedestrian mapping application 108 may typically exhibit an interface criterion 306 indicating a medium degree of user interaction (e.g., the user 102 may also be paying attention to the environment while using the application 108, such as minding traffic signals and avoiding other pedestrians while walking). The resulting user interface 110 may therefore select and arrange presentations 308 of the respective user interface elements 112 that satisfy these interaction component properties 302 and interaction criteria 306, such as an assistive textbox user interface element 112 that adaptively corrected incorrect input, and reduced detail in the presentation of information that facilitates a medium-attention user interaction 304.

As a fourth example, a vehicle-oriented mapping application 108 may also be used on a vehicle-mounted device featuring voice input mechanisms (rather than manual or touch-oriented input), and very limited visual output devices. Additionally, vehicle mapping may be used in a user interaction 304 that typically involves, as an interaction criterion 306, a low information density (e.g., presenting as little detail as possible to convey significant information, such as through a one-line text display or a text-to-speech output stream); and the user interaction 304 between the user 102 and the vehicle mapping application 108 may typically exhibit an interface criterion 306 indicating a low degree of user interaction (e.g., the user 102 may be primarily focused on vehicle navigation, and may have very limited attention available for interacting with the user interface 110). The resulting user interface 110 may therefore select and arrange presentations 308 of the respective user interface elements 112 that satisfy these interaction component properties 302 and interaction criteria 306, such as voice-oriented input user interface elements 112, and text output oriented to a highly reduced set of information that may be suitable for a one-line text display or a text-to-speech output stream. In this manner, the user interface 110 featuring a textbox, a button, and a content box may be automatically generated for a wide range of applications 108 in a manner that is particularly adapted to the interaction component properties 302 of the device 102 and the interaction criteria 306 of the user interaction 304 between the user 102 and the application 108, in accordance with the techniques presented herein.

### C. Technical Effects

The use of the techniques presented herein to generate user interfaces 110 adapted according to the interaction component properties 302 and the interaction criteria 306 of the user interaction 304 may result in a variety of technical effects.

As a first example of a technical effect that may be achievable by the techniques presented herein, a device 104 utilizing the techniques presented herein may enable the presentation of an application 108 with a user interface 110 that is well-adapted for a wide variety of devices 104, including hybrid devices 104 that do not fit within a traditional model of any class 208 of devices 104; exceptional devices 104 that exhibit unusual characteristics; and devices 104 in a new class 208 that was not envisioned by the application developer 202. Moreover, even for the devices 104 within a particular class 208, the techniques presented herein may enable a more adaptive user interface 110 by not coercing all such devices 104 into a “one size fits all” user interface 110.

As a second example of a technical effect that may be achievable by the techniques presented herein, a device 104 utilizing the techniques presented herein may adapt the user interface 110 of any application 108 composed of such user interface elements 112. That is, an operating environment or user interface framework may apply such adaptive user interface techniques to any application 108 based thereupon. Moreover, updates to the adaptation techniques (e.g., updating the set of available presentations 308 of each user interface element 112, or the logic whereby particular presentations 308 are selected for each user interface element 112 and generating the user interface 110 therefrom) may enhance the user interfaces 110 of a wide range of applications 108.

As a third example of a technical effect that may be achievable by the techniques presented herein, a device 104 utilizing the techniques presented herein may achieve adaptability of the user interfaces 110 of applications 108 without depending on the effort of an application developer 202. For example, rather than specifying the precise details of the appearance, behavior, and functionality of each user interface element 112, the application developer 202 may specify the collection of user interface elements 112 according to the role of each user interface element 112 in the user interface 110 of the application 108, such as the type of content to be displayed; the context in which the user 102 is anticipated to interact with the user interface element 112; the types of user interaction 304 that the user interface element 112 supports; and the attention and precision of the user 102 that the user interaction 304 with each user interface element 112 typically involves. A user interface 110 specified in this manner may be interpreted for presentation on a wide variety of devices 104, without depending upon the application developer 202 to craft specific user interfaces 110 for different classes 208 of devices 104 and to maintain the consistency through development. The development of applications 102 for a wide range of devices may therefore be made significantly easier for the application developer 202.

As a fourth example of a technical effect that may be achievable by the techniques presented herein, a device 104 utilizing the techniques presented herein may present to the user 102 a user interface 110 that more accurately reflects the interaction component properties 302 of the interaction components 106 of the device 102. As a first such example, the interaction component properties 302 may reflect a richer set of capabilities of the interaction components 106. A user interface 110 may reflect not only the basic functionality of a mouse, such as the presence and functionality of respective mouse buttons and a scroll wheel, but also characteristics of such functionality, such as the precision of mouse tracking, the discrete or continuous nature of the scroll wheel, and the positions of mouse buttons on the mouse. For a display, the user interface 110 may be adapted not only for the resolution and pixel density, but also for such properties as the contrast ratio; the physical size of the display; and the adaptiveness of the display to ambient light levels. As a second such example, the interaction component properties 302 utilized in the adaptation of the user interaction 110 may also involve properties other than the direct capabilities of the interaction components 106, such as the degree of precision that is typically achievable by the user 102 through an input device (e.g., a low-precision input such as a capacitative touch display vs. a high-precision input such as a mouse or stylus), and the degree of user attention to the device 104 that is typically involved (e.g., a mouse or stylus may depend upon a physical interaction between the user 102 and the device 104 as well as the hand-eye coordination of the user 102; but other forms of input, such as voice, orientation or tilt sensor, and a manual gesture detected by a camera, may be performed by the user 102 with a lower degree of attention to the device 104). The techniques presented herein may therefore enable a more precise adaptation of the user interface 110 to the interaction component properties 302 of the interaction components 106 of the device 104.

As a fifth example of a technical effect that may be achievable by the techniques presented herein, a device 104 utilizing the techniques presented herein may adapt the user interface 102 to the interaction criteria 306 of the user interaction 304 between the user 102 and the application 108. That is, the user interface 110 of the application 102 may automatically adapt to the user context in which the user 102 is utilizing the application 108, and to the particular type of content presented by the application 108. Such user interfaces 110 may also be dynamically updated to reflect changes in such interaction criteria 306, such as a transfer of the application 108 from a first device 104 to a second device 104 of a different type; changes in the user context of the user, such as standing, walking, and driving a vehicle; changes in the modality of the user interaction 304 of the user 102 with the device 104, such as changing from touch input to speech; and changes in the types of content presented by the application 108, such as text, pictures, video, and audio. Such automatic and dynamic adaptation may provide more flexibility than devices 104 that utilize a static user interface 110, that depend upon instructions from the user 102 to change the user interface 110, and/or that feature different applications that satisfy different types of user interaction 304.

As a sixth example of a technical effect that may be achievable by the techniques presented herein, a device 104 utilizing the techniques presented herein may adapt a user interface 110 to various properties automatically, rather than depending on an explicit interaction by the user 102. For example, many devices 104 adapt the user interface 110 of an application 108 in response to a specific action by the user 102, such as explicitly selecting a particular application, an application configuration, or an application mode, or toggling a “do not disturb” feature, such as a “silent”/“audible” switch positioned on the device 104. In addition to causing frustration, such user-mediated techniques may fail to adapt in the absence of such a user instruction; e.g., a device 104 featuring a “do not disturb” mode may nevertheless disturb a user 102 who forgets to enable it, and may withhold contact from a user 102 who forgets to disable it. By contrast, automatic user interface adaptation may enable an updating of the device behavior of the device 102 without depending upon an explicit instruction from the user 102, and may therefore more accurately respond to the user's circumstances. These and other technical effects may be achievable through the configuration of the device 104 to adapt the user interface 110 of an application 108 in accordance with the techniques presented herein.

### D. Example Embodiments

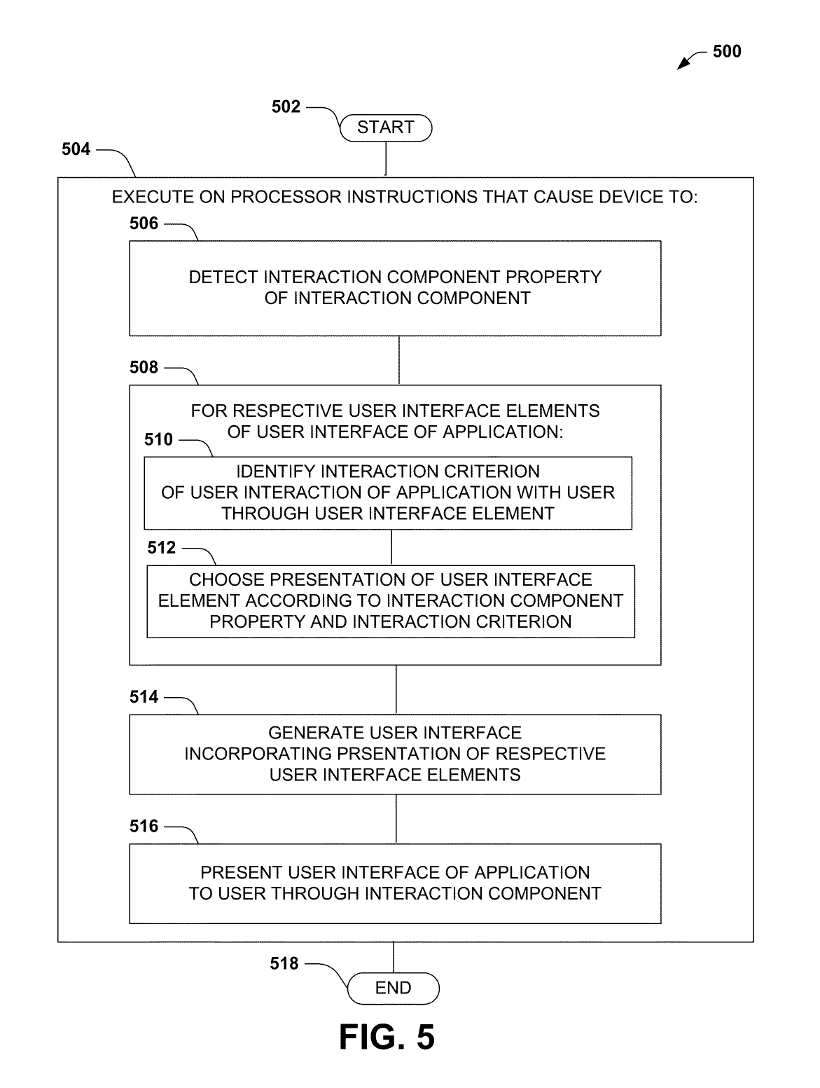

FIG. 5 presents a first example embodiment of the techniques presented herein, illustrated as an example method 500 of configuring a device 104 to presenting a user interface 110 for an application 108 through one or more interaction components 106. The example method 500 may be implemented, e.g., as a set of instructions stored in a memory component of the device 104, such as a memory circuit, a platter of a hard disk drive, a solid-state storage device, or a magnetic or optical disc, and organized such that, when executed on a processor of the device, cause the device 104 to operate according to the techniques presented herein.

The example method 500 begins at 502 and involves executing 504 the instructions on a processor of the device. Specifically, executing 504 the instructions on the processor causes the device 104 to detect 506 an interaction component property 302 of respective interaction components 106 of the device 104. Executing 504 the instructions on the processor also causes the device 104 to, for respective 508 user interface elements 112 of the user interface 110 of the application 108, identify 510 an interaction criterion 306 of a user interaction 304 of the application 108 with the user 102 through the user interface element 112; and choose 512 a presentation 308 of the user interface element 112 according to the interaction criterion 306 of the user interaction 304, and the interaction component property 302 of the interaction component 106. Executing 504 the instructions on the processor also causes the device 104 to generate 514 a user interface 110 that incorporates the presentation 308 of the respective user interface elements 112, and to present 516 the user interface 110 of the application 108 to the user 102 through the interaction component 106. In this manner, the instructions cause the device 104 to present applications 108 that are adapted for the interaction component properties 302 of the device 104 and the interaction criteria 306 of the user interaction 304 of the user 102 with the application 108 in accordance with the techniques presented herein, and so ends at 518.

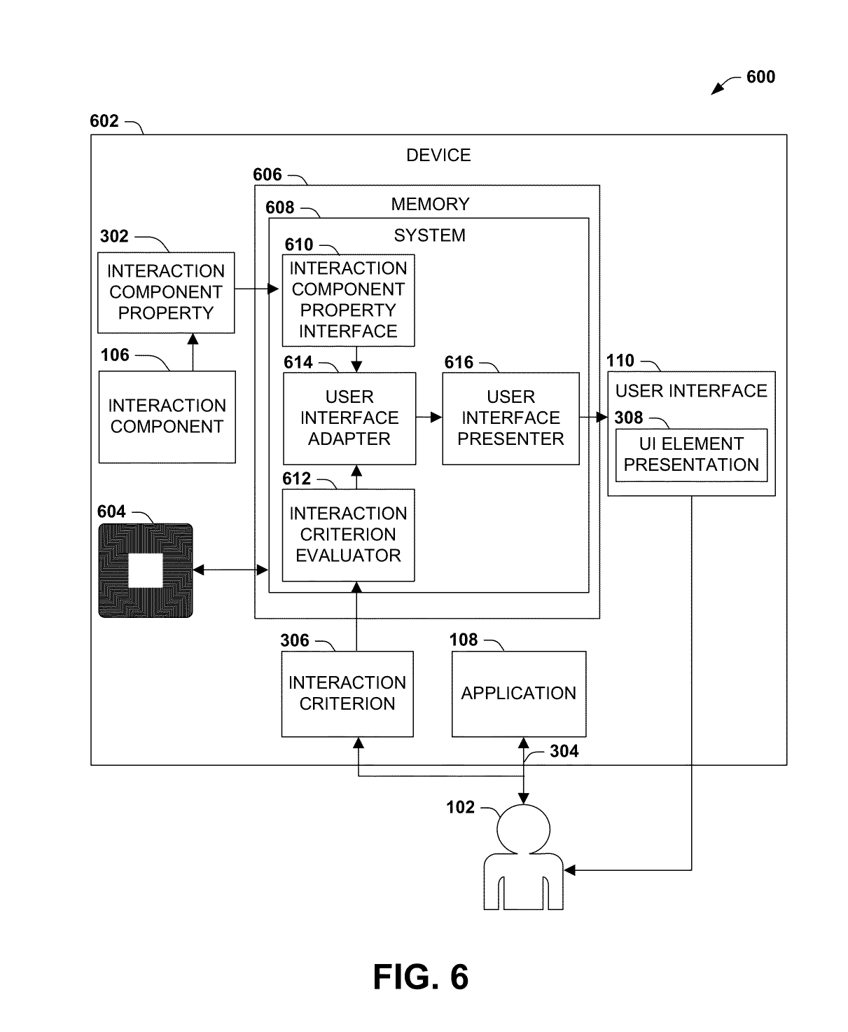

FIG. 6 presents a second example embodiment of the techniques presented herein, illustrated as an example system 608 implemented on an example device 602 featuring a processor 604, a memory 606, and at least one interaction component 106, where the example system 608 causes the device 602 to present the user interfaces 110 of applications 108 in accordance with the techniques presented herein. The example system 608 may be implemented, e.g., as a set of components respectively comprising a set of instructions stored in the memory 606 of the device 602, where the instructions of respective components, when executed on the processor 604, cause the device 602 to operate in accordance with the techniques presented herein.

The example system 608 comprises an interaction component property interface 610, which detects one or more interaction component properties 302 of one or more interaction components 106 of the example device 602. The example system 608 also comprises an interaction criterion evaluator 612, which identifies an interaction criterion 306 of a user interaction 304 of the application 108 with the user 102 through the user interface element 308. The example system 608 also comprises a user interface adapter 614, which, for respective user interface elements 112 of the user interface 110 of the application 108, chooses a presentation 308 of the user interface element 112 according to the interaction criterion 106 of the user interaction 304 and the interaction component property 302 of the interaction component 106. The example system 608 also comprises a user interface presenter 616, which generates the user interface 110 incorporating the presentation 308 of the respective user interface elements 112, and presents the user interface 110 of the application 108 to the user 102 through the interaction component 106. In this manner, the example system 608 enables the example device 602 to present the user interfaces 110 of applications 108 in accordance with the techniques presented herein.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

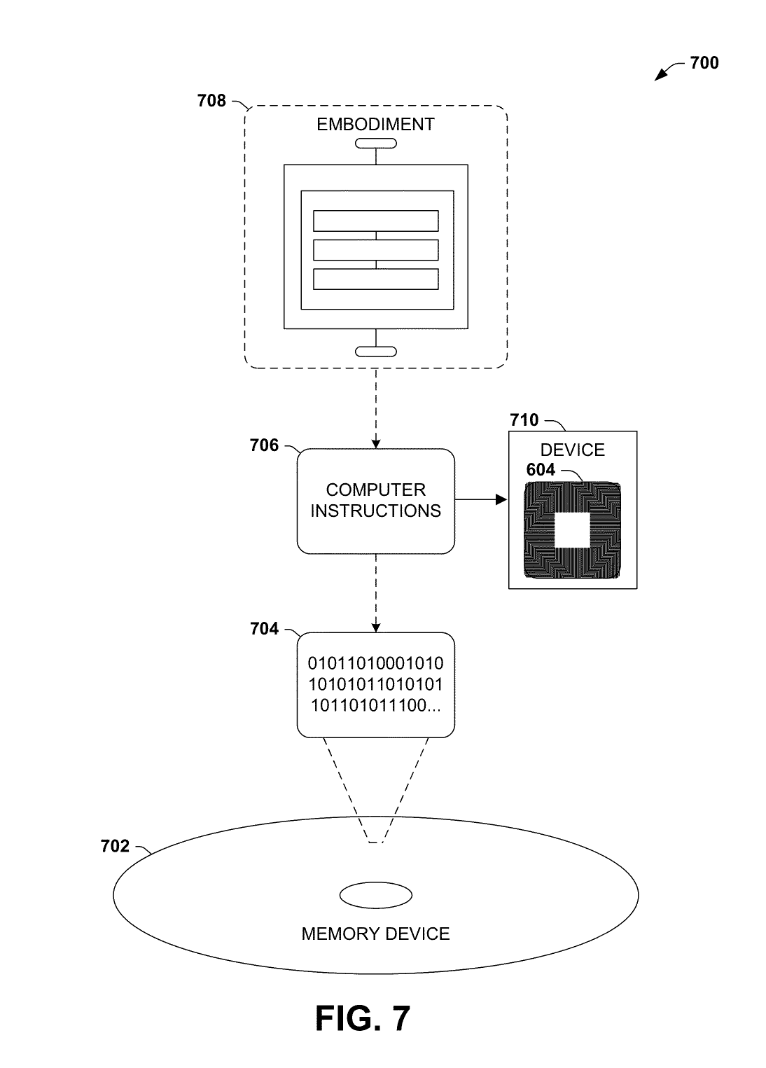

An example computer-readable medium that may be devised in these ways is illustrated in FIG. 7, wherein the implementation 700 comprises a computer-readable memory device 702 (e.g., a CD-R, DVD-R, or a platter of a hard disk drive), on which is encoded computer-readable data 704. This computer-readable data 704 in turn comprises a set of computer instructions 706 that, when executed on a processor 604 of a device 710 having at least two presentation components 106, cause the device 510 to operate according to the principles set forth herein. In a first such embodiment, the processor-executable instructions 706 may cause the device 710 to perform a method of presenting a user interface 110 of an application 108 to a user 102, such as the example method 500 of FIG. 5. In a second such embodiment, the processor-executable instructions 706 may cause the device 710 to present a user interface 110 of an application 108 to a user 102, such as the example system 608 of FIG. 6. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example method 500 of FIG. 5; the example system 608 of FIG. 6; and the example memory device 702 of FIG. 7) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 104, such as workstations, laptops, tablets, mobile phones, game consoles, portable gaming devices, portable or non-portable media players, media display devices such as televisions, appliances, home automation devices, computing components integrated with a wearable device integrating such as an eyepiece or a watch, and supervisory control and data acquisition (SCADA) devices.

As a second variation of this first aspect, the techniques presented herein may be utilized with a variety of applications 108 having a user interface 110, such as office productivity applications; media presenting applications, such as audio and video players; communications applications, such as web browsers, email clients, chat clients, and voice over IP (VoIP) clients; navigation applications, such as geolocation, mapping, and routing applications; utilities, such as weather and news monitoring applications that present alerts to the user 102; and games. These and other scenarios may be suitable for the presentation of applications 108 and user interfaces 110 through a variety of device 104 in accordance with the techniques presented herein.

E2. Interaction Components and Interaction Component Properties

A second aspect that may vary among embodiments of the techniques presented herein relates to the interaction components 106 that are utilized by such user interfaces 110, and the interaction component properties 302 thereof that enable the adaptation of the user interfaces 110.

As a first variation of this second aspect, the interaction components 106 may involve a variety of input components of a device 104, such as physical keyboards; mice; trackballs and track sticks; touchpads; capacitative touch displays, including multi-touch displays; stylus-based displays and pads. Such interaction components 106 may also interpret user input form various physical actions of the user, such as a microphone that evaluates instructions issued via the voice of the user 102, and cameras that detect body movements of the user 102, including hand movements performed without necessarily touching the device 104; gaze-tracking techniques; and wearable devices, such as earpieces, that detect a nod or shake of the user's head. Such interaction components 106 may also include physical sensors of the device 104, such as physical buttons or sliders provided on the device 104, or orientation sensors that detect the manipulation of the orientation of the device 104 by the user, such as tilting, tapping, or shaking the device 104. Such interaction components 106 may also receive various types of input, such as key-based text input; pointer input; and gestures.

As a second variation of this second aspect, the interaction components 106 may involve a variety of output components of the device 104, such as displays (e.g., liquid-crystal displays (LCDs), light-emitting diode (LED) displays, and “electronic ink” displays), including eyewear that presents output within the visual field of the user 102; speakers, including earpieces; and haptic devices, such as vibration motors that generate a pattern of vibration as an output signal to the user 102. Such output components may also comprise peripherals, such as printers and robotic components.

As a third variation of this second aspect, the interaction components 106 may involve further aspects of the device 104 that significantly affect the use of the device 104 by the user 102. As a first such example, the interaction of a user 102 with the device 104 may be affected by a general-purpose processor, or by a graphics or physics coprocessor. As a second such example, the interaction of a user 102 with the device 104 may involve communication with other devices, such as network adapters that communicate with other devices over a network; personal-area network devices that communicate with other devices over a short physical range, such as radiofrequency identifier (RFID) and/or near-field communication (NFC) devices; and scanners that read various types of information, such as barcode readers and quick response code (QR code) readers. Accordingly, the interaction component properties 302 may include information about the device 104 that may affect the suitability and/or responsiveness of the interaction components 106, such as the computational capacity of the device 104, network bandwidth and latency, available power, and ambient noise or light detected by the device 104 (e.g., which may limit the visibility of a display and/or the accuracy of voice detection by a microphone).

As a fourth variation of this second aspect, various interaction components 106 may relate to the device 104 in a number of ways. As a first such example, an interaction component 106 may be physically attached to the device 104, such as a physical keyboard embedded in the device housing, or a physical switch mounted on the device 104. As a second such example, the interaction component 106 may comprise a peripheral component that is connected to the device 104 using a bus, such as a universal serial bus (USB) connection. As a third such example, the interaction component 106 may connect wirelessly with the device 104 through various wireless communications protocols. As a fourth such example, the interaction component 106 may be a virtual component, such as an on-screen keyboard. As a fifth such example, the interaction component 106 may be attached to and/or part of another device, such as a mouse attached to a second device 104 that interacts with the user interface 110 of the first device 104.

As a fifth variation of this second aspect, the interaction components 106 may enable the application 108 to interact with the user 102 through a variety of presentation modalities, such as text, images, live and/or prerecorded video, sound effects, music, speech, tactile feedback, three-dimensional rendering, and interactive and/or non-interactive user interfaces, as well as various techniques for receiving user input from the user 102, such as text input, pointing input, tactile input, gestural input, verbal input, and gaze tracking input.

As a sixth variation of this second aspect, the interaction component properties 302 may include not just the basic functionality and capabilities of the respective interaction components 106, but also details about how such interaction components 106 are typically used by users 102. As a first such example, the interaction component properties 302 for an input component may include whether a user 102 is able to utilize the input component 106 with various degrees of precision, accuracy, and/or rate of input. For example, a mouse may enable a user 102 to provide precise pointer movement at a rapid pace, but may depend upon the user 102 interacting with the device 104 on a comparatively large tabletop. A trackball component may enable the user 102 to provide precise pointer movement, and may enable input in a continuous direction and manner, and without the physical space constraints of a tabletop surface, but may entail a lower data entry pace to provide precise movement. A stylus component may enable rapid and precise movement, and may also enable natural handwriting input and pressure-sensitive input, but may depend upon both a stylus-sensitive display, and the physical availability of the stylus. A touchpad component enables precise input, but with a lower input rate, and within the constraints of the physical size of the touchpad, which may inhibit long-distance pointer movement, and particularly dragging operations. A touch-sensitive display enables rapid data entry, but with comparatively poor precision, depends upon physical proximity of the user 102 to the display, and interferes with the user's view of the display. An orientation-sensor-based input mechanism may enable discreet interaction between the user 102 and the device 104, but may exhibit a high error rate. A camera that detects manual gestures may exhibit poor precision, accuracy, and a low input rate, and may depend upon training of the user 102 in the available gestures and the device 104 in the recognition thereof; however, a camera may be usable by the user 102 without contacting the device 104 and with a physical separation between the device 104 and the user 102; may be trained to recognize new gestures that the user 102 wishes to perform; and may accept concurrent input from several users 102.

While such details may significantly impact the usability of applications 108 and user interfaces 110. Some application developers 202 may take some such considerations into account while designing the user interface 110 of an application 108, but it may not be possible for an application developer 202 to adapt the user interface 110 to the particular interaction component properties 302 for a significant number of interaction components 106. Moreover, many such details may be unavailable to the application 108 and the application developer 202 due to the consolidation of the rich variety of interaction components 106 into a basic set of shared functionality. Because user interfaces 110 exhibit poor adaptability to the interaction component properties 302 of various interaction components 106, the task of matching the device 104 to the user interface 110 is often delegated to the user 102, and involves acquiring a suitable device 104 and interaction components 106 for a particular application 108; trying several applications 108 in order to find one that presents a suitable user interface 110 for the interaction components 106 of a particular device 104; and/or simply coping with and working around mismatches (e.g., performing long-distance dragging operations using a touchpad), and the lack of support of user interfaces 110 for particular functionality. By enabling the device 104 to fulfill the matching between the user interface 110 of an application 108 and the potentially rich set of interaction component properties 302 of the interaction components 106, the techniques presented herein provide alternative mechanisms for user interface composition that may provide a significantly improved user experience.

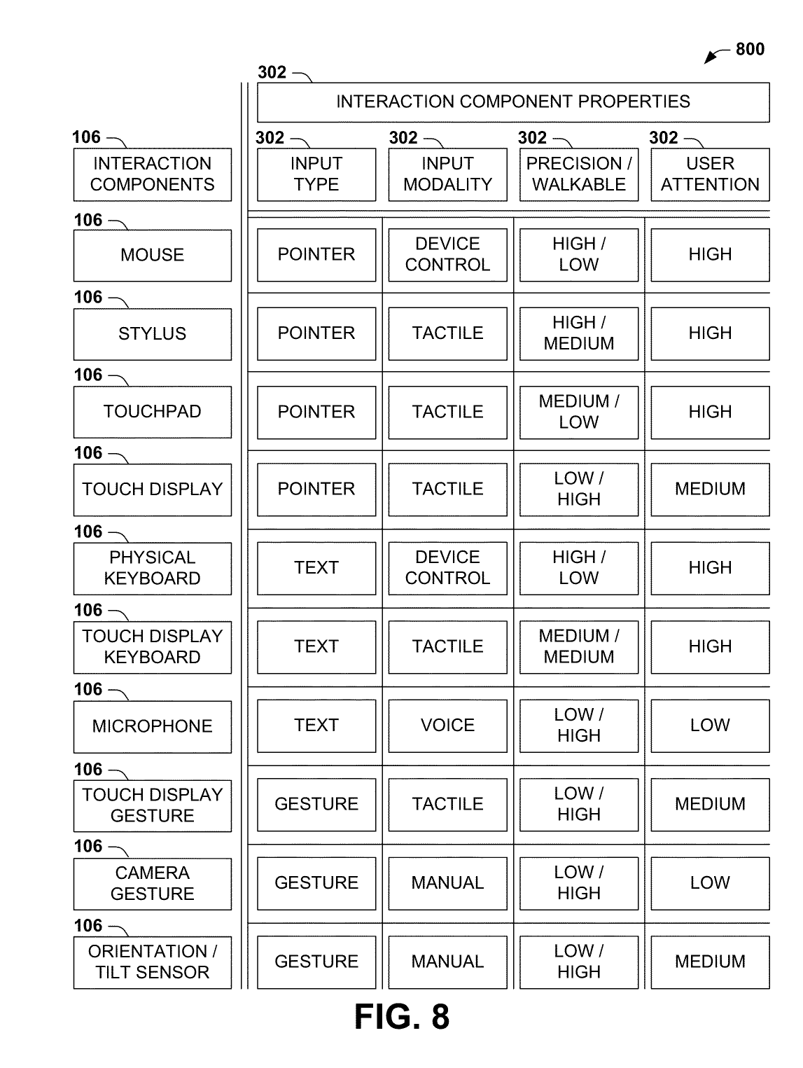

FIG. 8 presents an illustration of an example scenario 800 featuring a small collection of interaction component properties 302 that may represent various interaction components 106. For example, the interaction component properties 302 may include the basic functionality of each interaction component 106, such as the type of input receivable through an input component, and the input modality with which the user 102 communicates with the interaction component 106. The interaction component properties 302 may also include information about the input precision of each input component 106; whether or not the user 102 may be able to use the interaction component 106 in a particular circumstance, such as while walking; and the degree of user attention that using the interaction component 106 entails from the user 102 (e.g., the user 102 may have to pay closer attention to the device 104 while using a mouse or stylus than while using a touch-sensitive display or orientation sensor, and still less attention while providing voice input). The representation of each interaction component 106 using a rich and sophisticated set of interaction component properties 302 may enable the device 104 to achieve an automated composition of the user interface 110, in a manner that is well-adapted to the device 104, in accordance with the techniques presented herein.

E3. Interaction Criteria of User Interaction with Application

A third aspect that may vary among embodiments of the techniques presented herein involves the types of interaction criteria 306 of the user interaction 304 of the user 102 with the application 108 that are considered by the device 104 while generating the user interface 110.

As a first variation of this third aspect, the interaction criteria 306 may involve the roles of the respective user interface elements 112 in the user interface 110 of the application 108. As a first such example, a user interface element 112 may be interactive or non-interactive, and may support only particular types of user interaction, such as general selection of the entire user interface element 112, selection of a particular point or area therein, and one-dimensional or two-dimensional scrolling. For example, a textbox may accept input comprising only numbers; only simple text; formatted text featuring positioning, such as centering, and/or markup, such as bold; and/or input constrained by a grammar, such as hypertext markup language (HTML) or code in a programming language. As a second such example, a user interface element 112 may present various types of data, such as brief text (such as a username), concise text (such as an email message), or lengthy text (such as an article), and may or may not be accompanied by other forms of content, such as images, videos, sounds, and attached data. As a third such example, a user interface element 112 may provide various levels of assistance, such as spelling and grammar correction or evaluation, auto-complete, and associating input with related data that may be suggested to the user 102. As a fourth such example, a user interface element 112 may present content that is to be rendered differently in different circumstances, such as a password that may be revealed to the user 102 in select circumstances, but that is otherwise to be obscured. An application 108 that specifies a user interface 110 according to the roles of the user interface elements 112 in the user interface 110 may enable the device 104 to choose presentations 308 of such user interface elements 112 that are well-adapted to the circumstances of the user interaction 304 between a particular user 102 and a particular device 104.

As a second variation of this third aspect, the interaction criteria 306 may include predictions about the utility of the application 108 to the user 102, e.g., the circumstances in which the user 102 is likely to utilize the application 108. As a first such example, respective applications 108 may be intended for use in particular circumstances. For example, a recipe application may be frequently used in the user's kitchen and at a market; a bicycling application may be frequently used outdoors and while cycling; and a vehicle routing application may be frequently used while users are operating or riding in a vehicle. A device 104 that is informed of the utility of the application 108 may choose presentations 308 of user interface elements 112 that are well-suited for such utility. For example, applications 108 that are typically used at night may feature presentations 308 of user interface elements 112 that are well-adapted to low-light environments; applications 108 that are used outdoors may present user interfaces 110 that are well-adapted for low-attention engagement; and application 108 that are used in meetings may present user interfaces 110 that facilitate discreet interaction.

As a third variation of this third aspect, the interaction criteria 306 may include detection of the current circumstances and user context of the user interaction 304 of the user 102 with the application 104, e.g., the user's current location, current tasks, current role (such as whether the user 102 is utilizing the device 104 in a professional, academic, casual, or social context), and the presence or absence of other individuals in the user's vicinity. A device 104 that is aware of the user context of the user interaction 304 may adapt the user interface 110 accordingly (e.g., when the user 102 is in a meeting, the application 108 may exhibit a user interface 110 wherein the presentations 308 of the user interface elements 112 that enable a discreet user interaction 304; and when the user 102 is operating a vehicle, the application 108 may exhibit a user interface 110 that is oriented for low-attention interaction, such as voice input and output).

As a fourth variation of this third aspect, the interaction criteria 306 may include information about the relationship between the user 102 and the device 104, such as the physical distance between the user 102 and the device 104 (e.g., a half-meter interaction, a one-meter interaction, or a ten-meter interaction); whether or not the device 104 is owned by the user 102, is owned by another individual, or is a publicly accessible device 104; and the cost and/or sensitivity of the device (e.g., the user 102 may be more apt to use a “shake” gesture to interact with a rugged, commodity-priced device than a fragile, costly device).

As a fifth variation of this third aspect, the interaction criteria 306 may include details about whether the user 102 utilizes the device 104 and/or application 108 in isolation or in conjunction with other devices 104 and/or applications 108. As a first such example, if a first application 108 is often utilized alongside a second application 108, the user interface elements 112 of the user interfaces 110 may be selected in a cooperative manner in order to present a more consistent user experience. As a second such example, a first application 108 and a second application 108 that are often and/or currently used together may present a single, automatically merged user interface 110, and/or a consolidated set of user interface elements 112 that combine the functionality of the applications 108. As a third such example, when a first device 104 is used in conjunction with a second device 104 (e.g., a mobile phone and a car computer), the presentations 308 of the user interface elements 112 of the user interfaces 110 of the devices 104 may be selected together to provide a more consistent user experience (e.g., the user interface 110 of the second device 104 may automatically adopt and exhibit the aesthetics, arrangement, and/or user interface element types of the user interface 110 of the first device 104).

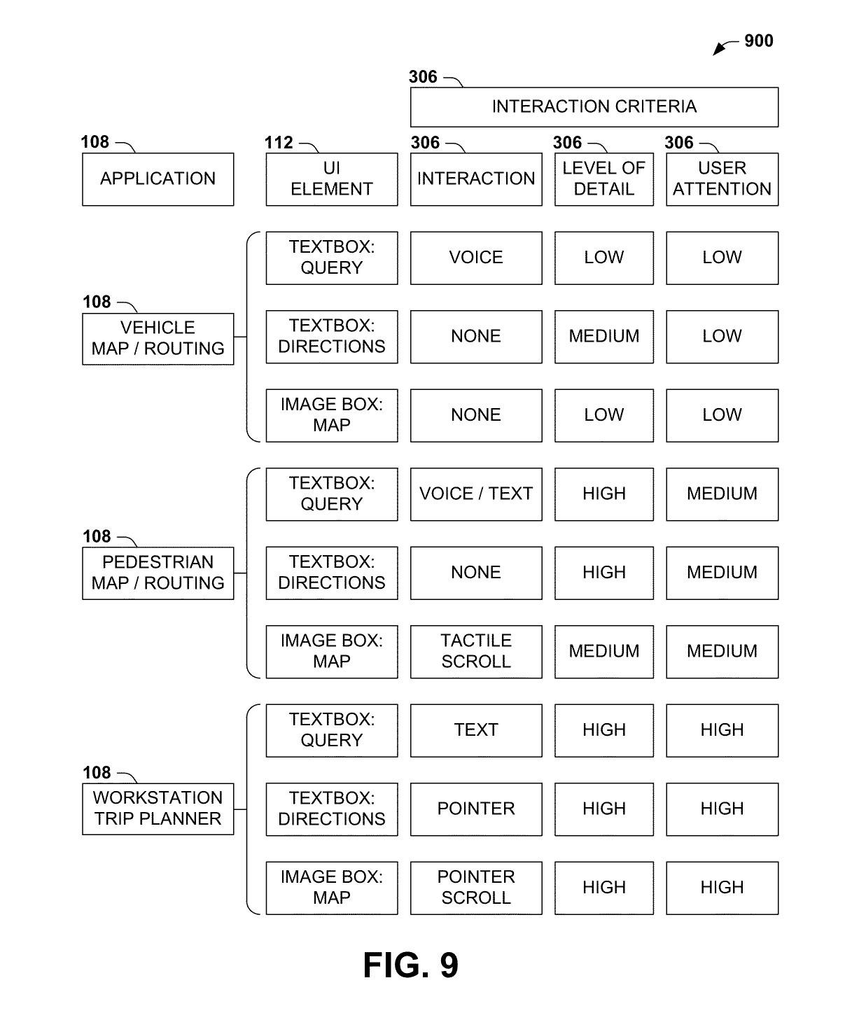

FIG. 9 presents an illustration of an example scenario 900 featuring a variety of interaction criteria 108 that may represent three types of mapping and routing applications 108. Each application 108 may present a user interface 110 comprising the same set of user interface elements 112, e.g., a textbox that receives a location query; a textbox that presents directions; and a map that shows an area of interest. However, the respective applications 108 may each exhibit different interaction criteria 306 in the user interaction 304 of the user 102 with the application 108, and with the particular user interface elements 112 of the user interface 110 of the application 108. As a first such example, the vehicle mapping and routing application 108 may be oriented around voice input and output; may endeavor to present a low level of detail in the presented content; and may be typically used in circumstances where the attention of the user 102 that is available for interacting with particular user interface elements 112 is limited. The pedestrian-oriented mapping and routing application 108 may request location queries through voice or text, depending on the noise level and walking rate of the user 102; may present a medium level of detail of the map that is viewable while walking, and a high level of detail of presented text to provide more precise walking directions; and may present a user interface 110 that is adapted for a medium attention availability of the user 102. The trip planning mapping and routing application 1080 may be typically used in a more focused environment, and may therefore present directions featuring selectable links with more information; a map that is oriented for pointer-based scrolling that is achievable in a workstation environment; robustly detailed maps; and user interface elements that involve a high level of user attention, such as precise pointing with a mouse input component. Applications 108 that provide information about the interaction criteria 306 about the user interaction 304 between the user 102 and the device 104 may enable an automated selection of the presentation 308 of the user interface elements 112 of the user interface 110 in accordance with the techniques presented herein.

E4. Choosing Interaction Components

A fourth aspect that may vary among embodiments of the techniques presented herein involves the selection of interaction components 106 of a device 104 for a particular application 108. Many devices 104 currently feature a large variety of interaction components 106 with varying interaction component properties 302; e.g., a mobile phone may feature a microphone, a camera, an orientation sensor, hard buttons embedded in the device, a display that is capable of recognizing touch input representing both pointer input and gestures; and also a display, an embedded set of speakers, and wired or wireless links to external displays and audio output devices. Some devices 104 may simply expose all such interaction components 106 to the user 102 and enable the user 102 to select any such interaction component 106 irrespective of suitability for a particular application 108. However, the techniques presented herein may enable the device 104 to map the user interface elements 112 of an application 108 to the interaction components 106 of the device 104. In addition to choosing the presentation 308 of user interface elements 112 that are suitable for the interaction component properties 302 of the available interaction components 106, the device 104 may also choose among the available interaction components 106 based on the user interface 110 of the application 108, and recommend an interaction component 106 to the user 102 for the user interaction 304 with the application 108.

As a first variation of this fourth aspect, among a set of available interaction components 106, a device 102 may map the interaction components 106 to the user interface elements 112 based on the current use of each such interaction component 106. For example, a first display may be more suitable for a particular user interface element 112 than a second display, but the first display may be heavily utilized with other applications 108, while the second display is currently free and not in use by any applications 108. The second display may therefore be selected for the user interface 110 of the application 108.

As a second variation of this fourth aspect, among the set of available interaction components 106, a device 102 may map the interaction components 106 to the user interface elements 112 based on the availability of presentations 308 of the user interface element 112 for the interaction component 106. For example, the device 104 may simply not have a presentation 308 for a particular user interface element 112 that is suitable for a particular interaction component 106 (e.g., it may not be possible to use a vibration motor to present the content of an image box).

As a third variation of this fourth aspect, where at least two interaction components 106 are accessible to the device 104, and the user interface 110 comprises at least two user interface elements 112, the device 104 may perform a mapping of interaction components 106 to user interface elements 112. For example, for the respective user interface elements 112, the device 104 may compare the interaction component properties 302 of the respective interaction components 106, and among the available interaction components 106, may select an interaction component 106 for the user interface element 112. The device 104 may then present the user interface 110 to the user 102 by binding the selected interaction components 106 to the respective user interface elements 112 (e.g., allocating a region of a display for a visual presentation of the user interface element 112; inserting audio output from the user interface element 112 into an audio stream of a set of speakers or headphones; and/or reserving an input device for providing user input to the user interface element 112). Such selection may be performed in a variety of ways. As a first such example, the user 102 may specify a user preference for a first interaction component 106 over a second interaction component 106 while interacting with the selected user interface element 112 (e.g., a general user preference of the user 102 for a mouse over touch input, or a user preference of the user 102 specified for a particular application 108 and/or type of user interface element 112), and the device 104 may select the interaction component 108 for the selected user interface element 112 according to the user preference. As a second such example, the interaction criteria 306 of the application 108 and/or for the user interface element 112 may inform the selection of a particular interaction component 106; e.g., the device 104 may an interaction suitability of the respective interaction components 106 according to the application criteria 306, and may select a first interaction component 106 over a second interaction component 106 for a particular user interface element 112 based on the interaction suitability of the respective interaction components 106.

As a fourth variation of this fourth aspect, an interaction component 106 that may be usable with the application 108 may be accessible to the device 104 through an auxiliary device. For example, an application 108 executing on a workstation may utilize the touch-sensitive display of a mobile phone as an interaction component 106. Binding such an interaction component 106 to the user interface element 112 may therefore involve notifying the auxiliary device to bind the selected interaction component 106 to the user interface element 112 (e.g., initiating an input stream of user input from the interaction component 106 from the auxiliary device to the device 104 for use by the user interface element 112, and/or initiating an output stream from the device 104 to the interaction component 106 of the auxiliary device to present the output of the user interface element 112). Moreover, in some scenarios, the device 104 may map several user interface elements 112 of the application 108 to different interaction components 106 of different auxiliary devices (e.g., a first interaction component 106 may be accessible through a first auxiliary device, and a second interaction component 106 may be accessible through a second auxiliary device; and for a user interface 110 further comprising a first user interface element 112 and a second user interface element 112, the device 104 may selecting the first interaction component 106 for the first user interface element 112, and the second interaction component 106 for the second user interface element 112). In some scenarios, the device 104 may map all of the user interface elements 112 of the application 108 among a set of auxiliary devices, thereby distributing the entire user interface 110 of the application 110 over a device collection of the user 102 (e.g., a workstation that receives an incoming call may map a notification user interface element 112 to the vibration motor of a mobile phone in the user's pocket; may map an audio input user interface element 112 to a microphone in the user's laptop; and may map an audio output user interface element 112 to the user's earpiece).

As a fifth variation of this fourth aspect, interaction components 106 may exhibit a variable availability; e.g., peripherals and other devices may be powered on, may be powered off or lose power due to battery exhaustion, may initiate or lose a wired or wireless connection with the device 104, and may be reassigned for use by other applications 108 or become available thereafter. The device 104 may adapt to the dynamic availability of the interaction components 106 in a variety of ways. As a first such example, when an auxiliary device becomes accessible, the device 104 may, responsive to establishing a connection with the auxiliary device, profile the auxiliary device 106 to detect the interaction components 106 of the auxiliary device and the interaction component properties 302 thereof. As a second such example, when a new interaction component 106 becomes accessible, the device 104 may compare the interaction component properties 302 of the new interaction component 106 with those of a currently selected interaction component 106 for a user interface element 112; and upon selecting the new interaction component 106 over the selected interaction component 106 for a selected user interface element 112, the device 104 may unbind the selected interaction component 106 from the selected user interface element 112, an bind the new interaction component 106 to the selected user interface element 112. As a third such example, responsive to detecting an inaccessibility of a selected input component 106 for a selected user interface element 112 (e.g., a disconnection from an auxiliary device having at least one interaction component 106 mapped to a locally executing application 108), the device 104 may select a second interaction component 108 for the user interface element 112, and bind the second interaction 106 component to the user interface element 112. Many such techniques may be included to adapt the selection of interaction components 106 for the respective user interface elements 112 of the user interface 110 of an application 108 in accordance with the techniques presented herein.

E5. Choosing User Interface Element Presentations

A fifth aspect that may vary among embodiments of the techniques presented herein involves the selection of a presentation 308 of a user interface element 112, in view of the interaction component properties 302 and the interaction criteria 306 of the user interaction 304 of the user 102 and the application 108.

As a first variation of this fifth aspect, many aspects of a user interface element 112 may be selected and/or adapted to provide a presentation 308 for a particular user interface 110. As a first such example, the adaptations may include the appearance of the user interface element 112, such as its size, shape, color, font size and style, position within the user interface 110, and the inclusion or exclusion of subordinate user interface controls (“chrome”) that allow interaction with the user interface element 112. For audio-based user interface elements 112, the adaptation for a particular presentation 308 may include the timing, pitch, volume, and/or duration of a sound.

As a second variation of this fifth aspect, a user interface element 112 for a particular presentation 308 may include adapting the behavior and/or functionality of the user interface element 112 to match a particular interaction component 106. For example, a scrollable user interface element 112 may provide different presentations 308 that exhibit different scroll behavior when associated with a mouse featuring or lacking a scroll wheel; with a touchpad; and with a touch-based display. Accordingly, among at least two presentations 308 of the user interface element 112 that are respectively adapted for an interaction component type of interaction component 106, the device 104 may choose the presentation 308 of the user interface element 112 that is associated with the interaction component type of the selected interaction component 106.

As a third variation of this fifth aspect, the presentation 308 of a user interface element 112 may be selected based on an interaction modality of the user interface element 112 with the user interaction 304. For example, a first presentation 308 of a textbox may be adapted for receiving and/or expressing short text phrases, such as text messages; a second presentation 308 of a textbox may be adapted for receiving and/or expressing long messages, such as a text reading and/or text editing interface; a third presentation 308 of a user interface element 112 may be adapted for audio interaction, such as voice input and/or text-to-speech output; and a fourth presentation 308 of a textbox may be adapted for tactile interaction, such as a braille mechanical display. Accordingly, the device 104 may identify an interaction modality of a user interface element 112, and among at least two presentations 308 of the user interface element 112 that are respectively adapted for a particular interaction modality, may choose the presentation 308 of the user interface element 112 that is associated with the interaction modality of the user interaction 304.

As a fourth variation of this fifth aspect, the presentation 308 of a user interface element 112 may be selected based on an interaction criterion 306 representing a predicted attentiveness of the user 102 to the user interface element 112 during the user interaction 304 (e.g., whether the context in which a user 102 uses the application 108 is predicted and/or detected to involve focused user attention, such as in a desktop setting; partial user attention, such as in a pedestrian setting; and limited user attention, such as while the user 102 is operating a vehicle). Accordingly, a device 104 may choose the presentation 308 of the user interface element 112, from among at least two presentations 308 of the user interface element 112 that are respectively adapted for a content volume of content through the user interface element, by choosing a presentation 308 that presents a content volume matching the predicted attentiveness of the user 102 to the user interface element 112.

As a fifth variation of this fifth aspect, a device 104 may adapt the content presented by a presentation 308 based on the interaction criteria 306 and the interaction component properties 302. For example, where the device 104 presents a visual user interface element 112 on a large display in a context with a high information density for which the user 102 has high attention availability, the device 104 may select a presentation 308 that exhibits a full rendering of content; and where the device 104 presents the user interface element 112 on a smaller display, or on a large display but in the context of a low information density or where the user 102 has limited available attention, the device 104 may select a presentation 308 that reduces the amount of information, such as providing a summary or abbreviation of the content.

As a sixth variation of this fifth aspect, a device 104 may compare the settings of an interaction component 106 with the properties of a presentation 308 of a user interface element 112, and may adapt the settings of the interaction component 106 and/or the properties of the presentation 308 to satisfy the mapping. As a first such example, an audio output component may be selected to present an audio alert to the user, but the interaction criteria 306 may entail a selection of a high-volume alert (e.g., an urgent or high-priority message) or a low-volume alert (e.g., a background notification or low-priority message). The device 104 may adapt the volume control of the audio output component to a high or low setting, and/or may scale the volume of the audio alert to a high or low volume, according to the interaction criteria 306. As a second such example, the interaction criteria 306 of a scrollable user interface element 112 may include high-precision scrolling (e.g., a selection among a large number of options) or low-precision scrolling (e.g., a selection among only two or three options), and the device 104 may either set the sensitivity of an interaction component 106 (e.g., the scroll magnitude of a scroll wheel), and/or scale the presentation 308 of the user interface element 112 to suit the interaction criterion 306.

As a seventh variation of this fifth aspect, a selected presentation 308 of a user interface element 112 may be included in a user interface 110 in many ways. As a first such example, the device 104 may programmatically adapt various properties of a user interface element 112 in accordance with the selected presentation 308. As a second such example, the device 104 may manufacture the selected presentation 308 of a user interface element 112 (e.g., using a factory design pattern to generate a user interface element 112 exhibiting a desired appearance, behavior, and functionality). A third such example, the device 104 may have access to a user interface element library, which may comprise, for the respective user interface elements 112, at least two presentations 308 of the user interface element 112 that are respectively adapted for a selected set of interaction component properties 302 and/or interaction criteria 306. The device 104 may therefore generate the user interface 110 by selecting the presentation 308 from the user interface element library that is adapted for the interaction component properties 302 and the interaction criteria 306 of the user interaction 304.

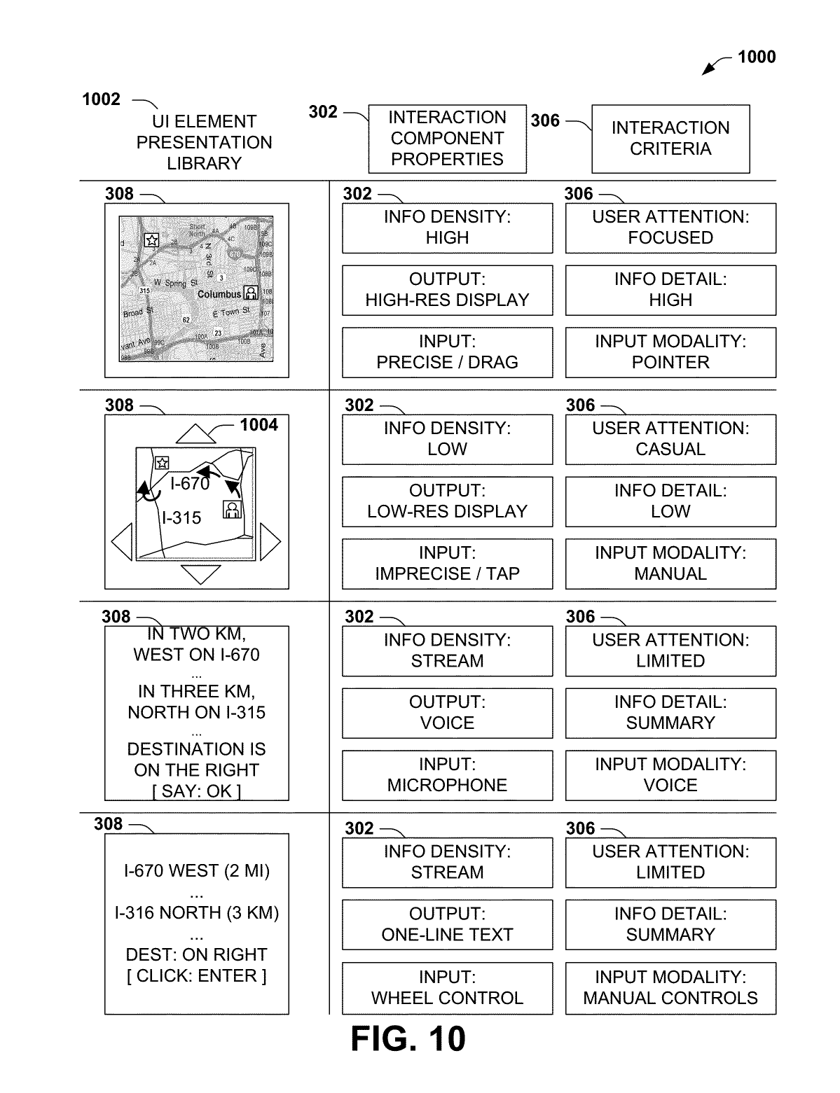

FIG. 10 presents an illustration of an example scenario 1000 featuring a portion of a user interface element presentation library 1002, featuring four presentations 308 of a user interface element 112 comprising a map, where the respective presentations 308 are suitable for a particular collection of interaction component properties 302 and/or interaction criteria 306. For example, a first presentation 308 may display a map with a high information density that is suitable for a high-resolution display, and may enable precise pointer input using drag operations, which may enable an exclusion of “chrome” subordinate user interface controls. A second presentation 308 may be adapted for low-information-density and low-resolution displays; may present a reduced set of visual information that is suitable for medium-attention user interactions 304, such as pedestrian environments, such as the inclusion of oversized controls 1004 that enable basic interaction; and may accept imprecise tap input in touch-based interactions. A third presentation 308 may be adapted for stream-based audio communication; may accept voice input and respond via text-to-speech output; and may reduce the presented information in view of an anticipated limited user attention and communication bandwidth of audio-based user interfaces. A fourth presentation 308 may be adapted for one-line text output, such as in a vehicle dashboard display, and may therefore provide a stream of one-line text instructions; may adapt user interaction based on a wheel control input, such as an “OK” button; and may condense presented content into a summary in order to provide a low-information-density presentation 308. A inter interface element presentation library 1002 may present a large variety of presentations 308 of a variety of user interface elements 112 in order to facilitate the adaptability of the presentation 308 of the user interfaces 110 to the interaction component properties 302 of the interaction components 106 bound to the application 108, and the interaction criteria 306 of the user interaction 304 of the user 102 with the application 108.

As an eighth variation of this fifth aspect, in view of the rich set of information upon which the selection of presentations 308 of various user interface elements 112 may be based, it may be difficult for a device 104 to perform such selection. For example, for a particular set of interaction component properties 302 among a diverse set of available interaction components 106 and a detailed set of interaction criteria 306 describing the user interaction 304, none of several available presentations 308 may satisfy all of such interaction component properties 302 and interaction criteria 306, and compromises may have to be made to choose a particular presentation 308.

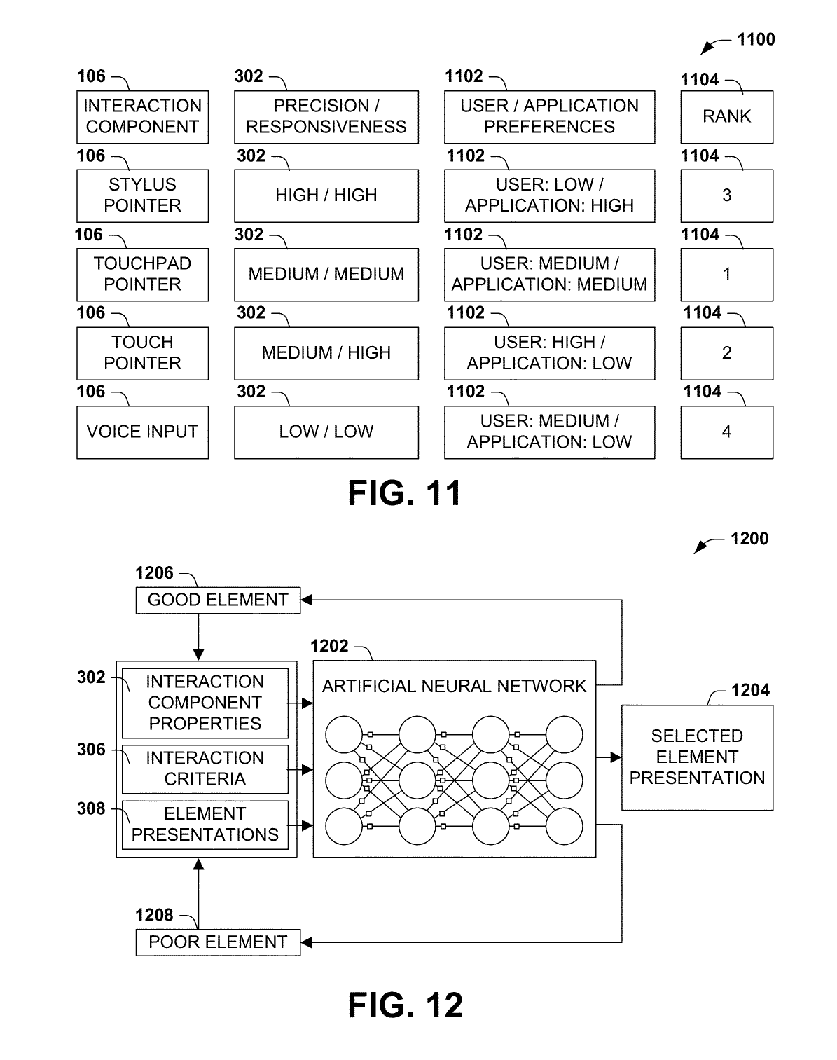

FIG. 11 presents an illustration of an example scenario 1100 featuring a first such variation for achieving the selection, among a set of interaction components 106 available on a device 104, of a selected interaction component 106 to bind to a presentation 308 of a user interface element 112. In this example scenario 1100, various interaction criteria 306 (e.g., the input precision with which the user interface 110 is to interact with the user 102, and the significance of responsive user input) are compared with the interaction component properties 302 of the respective interaction components 106 (e.g., the input precision that is achievable with the respective interaction components 106, and the speed with which the respective interaction components 106 provide input). Additionally, preferences 1102 may have been specified by both the user 102 and the application 108 for the respective interaction components 106. The device 104 may utilize a scoring system in order to assess the set of factors for each interaction component 106, optionally ascribing greater weight to some factors than to others, and may establish a rank 1104 of the interaction components 106 that enables a selection. If the top-ranked interaction component 106 becomes unavailable, or if the user 102 requests not to use the selected interaction component 106, the second-highest-ranked interaction component 106 may be selected instead, etc. In this manner, the ranking of interaction components 106 may enable the device 104 to choose the interaction component 106 for a particular user interface element 112. Similar ranking may be utilized, e.g., for the available presentations 308 of each user interface element 112; one such embodiment may perform a two-dimensional ranking of the pairing of each interaction component 106 and each presentation 308 in order to identify a highest-ranked mapping thereamong.

FIG. 12 presents an illustration of an example scenario 1200 featuring a second such variation for achieving a selection, involving the use of a learning algorithm, such as an artificial neural network 1202, to identify the selection of presentations 308 of user interface elements 112. In this example scenario 1200, the artificial neural network may comprise a set of nodes arranged into layers and interconnected with a weight that is initially randomized. In a supervised training model, the artificial neural network 1202 may be provided with a training data set (e.g., an indication of which presentation 308 is to be selected in view of particular combinations of interaction component properties 302 and interaction criteria 306), and the weights of the nodes of the artificial neural network 1202 may be incrementally adjusted until the output of the artificial neural network 1202, in the form of a selection 1204 of one of the presentations 308, matches the presentation 308 known or believed to be the correct answer. Continued training may enable the artificial neural network 1202 to achieve an accuracy satisfying an accuracy confidence level. Thereafter, the artificial neural network 1202 may be invoked to evaluate a selected set of interaction component properties 302 and interaction criteria 306 for a particular user interface 110, and to identify the selection 1204 of a presentation 308 therefor. Moreover, feedback may be utilized to refine and maintain the accurate output of the artificial neural network 1202; e.g., the user interaction 304 of the user 102 with the application 106 through the selected presentation 308 may be monitored and the proficiency automatically evaluated, such that a first presentation 308 that reflects a suitable user interaction 304 (e.g., a low error rate) may prompt positive feedback 1206 that increases the selection 1204 of the first presentation 308, while a second presentation 308 that reflects an unsuitable user interaction 304 (e.g., a high error rate, or a request from the user 102 to choose a different interaction component 106) may prompt negative feedback 1208 that decreases the selection 1204 of the second presentation 308. Many such techniques may be utilized to choose a presentation 308 of a user interface element 112 for a user interface 110 in accordance with the techniques presented herein.

E6. Generating and Presenting User Interface

A sixth aspect that may vary among embodiments of the techniques presented herein involves the manner of generating the user interface 110 from the selected presentations 308 of user interface elements 112, and of presenting the user interface 110 to the user 102.

As a first variation of this sixth aspect, the generation of the user interface 110 may also utilize the interaction component properties 302 of the interaction components 106 and/or the interaction criteria 306 of the user interaction 304 of the user 102 with the application 108. As one such example, the user interface 110 may be arranged according to factors such as information density. For example, on a first device 104 having a large display and presenting an application 108 that entails a low degree of user attention, the user interface 110 may be arranged with a low information density, i.e., in a sparse manner; while on a second device 104 having a small, handheld display and presenting an application 108 that entails a high degree of user attention, the user interface 110 may be arranged with a high information density, i.e., in a condensed manner.

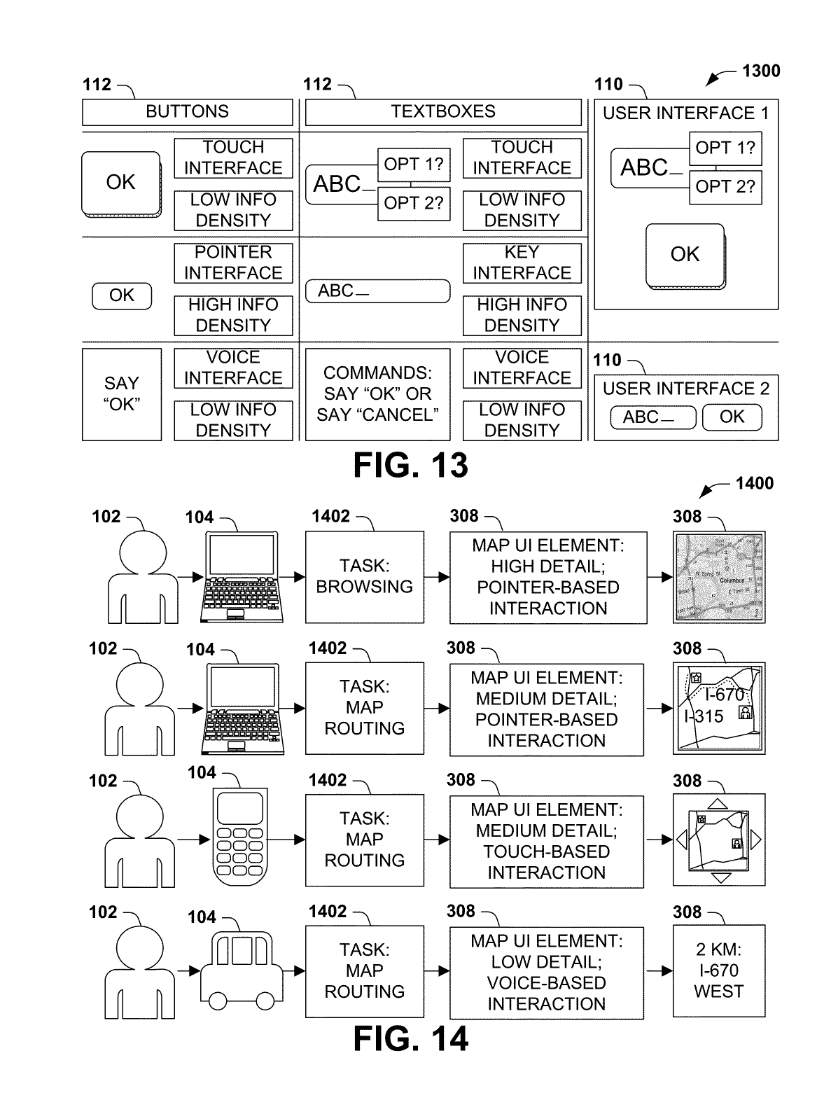

FIG. 13 presents an illustration of an example scenario 1300 featuring a variable presentation of user interfaces 110 that are adapted both using the selection of particular presentations 308 of user interface elements 112, and also reflecting an information density of the user interfaces 110. In this example scenario 1300, two instances of a user interface 110 comprising user interface elements 112 including a button and a textbox are generated and presented that satisfy different interaction component properties 302 and the interaction criteria 306. For example, a first user interface 110 not only utilizes large controls with adaptive options that are suitable for a touch-based interface, but also provides a low information density (e.g., ample spacing among user interface elements 112). Conversely, a second user interface 110 provides pointer-sized controls that may be precisely selected by a pointer-based user interface component 106 such as a mouse or stylus, and with a high information density (e.g., conservative spacing among user interface elements 112). In this manner, different user interfaces 110 may be generated from the incorporation of various presentations 308 of user interface elements 112 in accordance with the techniques presented herein.

As a second variation of this sixth aspect, while presenting the user interface 110 to the user 102, the device 104 may detect an interaction performance metric of the user interaction 304 of the user 102 with the respective user interface element 112 of the user interface 110. Responsive to detecting an interaction performance metric for a selected user interface element 110 that is below an interaction performance metric threshold, the device 104 may choose a second presentation 308 of the user interface element 112, and substitute the second presentation 308 of the user interface element 112 in the user interface 110.

As a third variation of this sixth aspect, while presenting the user interface 110 of an application 108, the device 104 may monitor the user interaction 304 to detect and respond to changes in the interaction criteria 306. For example, as the user's location, role actions, and tasks change, and as the content provided by the application 108 changes, the user interface 110 may be dynamically reconfigured to match the updated circumstances. For example, responsive to detecting an updated interaction criterion 306 of the user interaction 304 between the user 102 and the device 104, the device 104 may reevaluate the selection of presentations 308 for user interface elements 112; and upon choosing a second presentation 308 of a particular user interface element 112 according to the updated interaction criterion 306, the device 104 may substitute the second presentation 308 of the user interface element 112 in the user interface 110.

FIG. 14 presents an illustration of an example scenario 1400 featuring the dynamic reconfiguration of a user interface 110 of a mapping and routing application 108 as the interaction component properties 302 and the interaction criteria 306 of the user interaction 304 change. In this example scenario 1400, at a first time, the user 102 may be utilizing a first device 104, such as a laptop, to perform the task 1402 of browsing a map of an area. Accordingly, the device 104 may feature a first presentation 308 of the map user interface element 112 as a highly detailed image that is responsive to pointer-based interaction. At a second time, the user 102 may choose a different task 1402, such as identifying a route from a current location to a second location on the map. Accordingly, the device 104 may detect that the user interface element 112 now presents a different type of content, and may substitute a second presentation 308 of the map user interface element 112 that features a medium level of detail and pointer interaction. At a third time, the user 102 may transfer the application 108 to a second device 104, such as a mobile phone, which has a different set of interaction component properties 302 (e.g., a touch-sensitive display rather than a mouse) and presents different interaction criteria 306 (e.g., a lower level of available user attention, in case the user 102 is walking while using the device 104). Accordingly, the application 108 may substitute a third presentation 308 of the amp user interface element 112 that includes touch-based controls that are suitable for a walking context. At a fourth time, the user 102 may transfer the application 108 to a third device 104 comprising a vehicle, which presents other updates in the interaction component properties 302 and interaction criteria 306. Accordingly, the device 104 may substitute a fourth presentation 308 of the map user interface element 112, featuring voice-based routing instructions that may be spoken to the user 102 during the operation of the vehicle. In this manner, the user interface 110 of the application 108 may be automatically adapted to changing circumstances in accordance with the techniques presented herein.

### F. Computing Environment

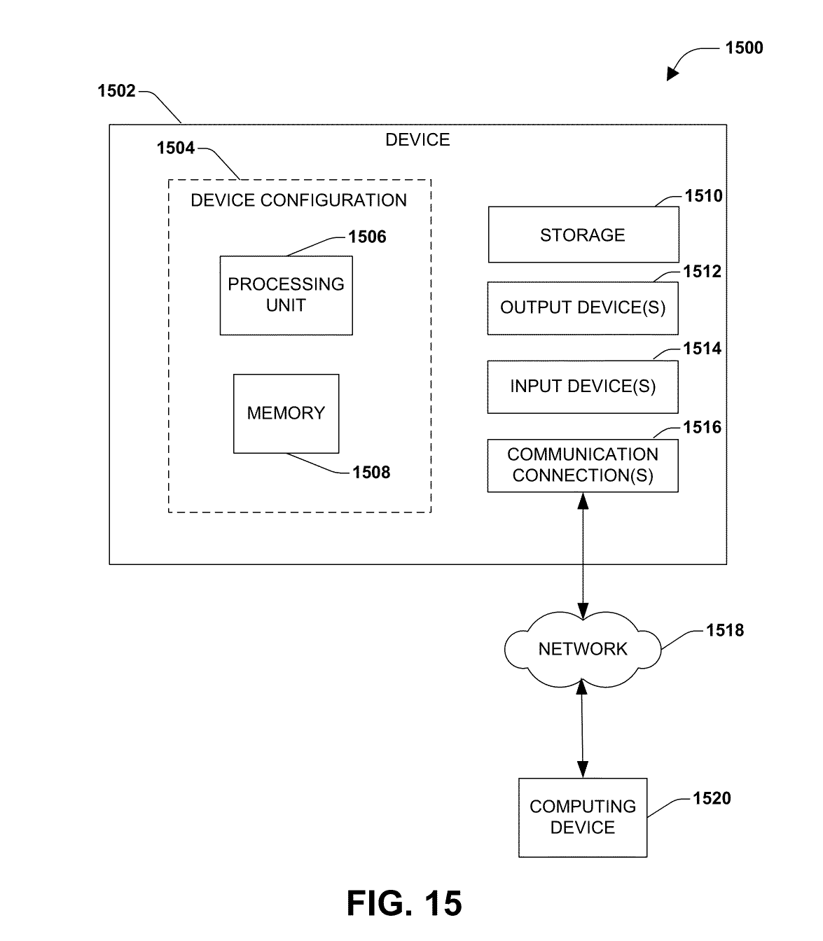

FIG. 15 and the following discussion provide a brief, general description of a suitable computing environment to implement embodiments of one or more of the provisions set forth herein. The operating environment of FIG. 15 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 15 illustrates an example of a system 1500 comprising a computing device 1502 configured to implement one or more embodiments provided herein. In one configuration, computing device 1502 includes a processing unit 1506 and memory 1508. Depending on the exact configuration and type of computing device, memory 1508 may be volatile (such as RAM, for example), non-volatile (such as ROM, flash memory, etc., for example) or some combination of the two. This configuration is illustrated in FIG. 15 by dashed line 1504.

In other embodiments, device 1502 may include additional features and/or functionality. For example, device 1502 may also include additional storage (e.g., removable and/or non-removable) including, but not limited to, magnetic storage, optical storage, and the like. Such additional storage is illustrated in FIG. 15 by storage 1510. In one embodiment, computer readable instructions to implement one or more embodiments provided herein may be in storage 1510. Storage 1510 may also store other computer readable instructions to implement an operating system, an application program, and the like. Computer readable instructions may be loaded in memory 1508 for execution by processing unit 1506, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1508 and storage 1510 are examples of computer storage media. Computer-storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1502 may also include communication connection(s) 1516 that allows device 1502 to communicate with other devices. Communication connection(s) 1516 may include, but is not limited to, a modem, a Network Interface Card (NIC), an integrated network interface, a radio frequency transmitter/receiver, an infrared port, a USB connection, or other interfaces for connecting computing device 1502 to other computing devices. Communication connection(s) 1516 may include a wired connection or a wireless connection. Communication connection(s) 1516 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1502 may include input device(s) 1514 such as keyboard, mouse, pen, voice input device, touch input device, infrared cameras, video input devices, and/or any other input device. Output device(s) 1512 such as one or more displays, speakers, printers, and/or any other output device may also be included in device 1502. Input device(s) 1514 and output device(s) 1512 may be connected to device 1502 via a wired connection, wireless connection, or any combination thereof. In one embodiment, an input device or an output device from another computing device may be used as input device(s) 1514 or output device(s) 1512 for computing device 1502.

Components of computing device 1502 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1502 may be interconnected by a network. For example, memory 1508 may be comprised of multiple physical memory units located in different physical locations interconnected by a network.

Those skilled in the art will realize that storage devices utilized to store computer readable instructions may be distributed across a network. For example, a computing device 920 accessible via network 1518 may store computer readable instructions to implement one or more embodiments provided herein. Computing device 1502 may access computing device 1520 and download a part or all of the computer readable instructions for execution. Alternatively, computing device 1502 may download pieces of the computer readable instructions, as needed, or some instructions may be executed at computing device 1502 and some at computing device 1520.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting a user interface for an application through an interaction component, the method involving a device having a processor and comprising:
executing, on the processor, instructions that cause the device to:
detect an interaction component property of the interaction component;
for respective user interface elements of the user interface of the application:
identify an interaction criterion of a user interaction of the application with the user through the user interface element; and
choose a presentation of the user interface element according to the interaction criterion of the user interaction and the interaction component property of the interaction component;
generate the user interface incorporating the presentation of the respective user interface elements; and
present the user interface of the application to the user through the interaction component.

2. The method of claim 1, wherein:
at least two interaction components are accessible to the device;
the user interface further comprises at least two user interface elements;
executing the instructions further causes the device to, for the respective user interface elements:
compare the interaction component property of the respective interaction components; and
among the respective interaction components, select a selected interaction component for the user interface element; and
presenting the user interface further comprises: for the respective user interface elements, binding the selected interaction component to the user interface element.

3. The method of claim 2, wherein selecting the selected interaction component further comprises:
identifying, for a selected user interface element, a user preference of the user for a first interaction component over a second interaction component while interacting with the selected user interface element; and
selecting the first interaction component for the selected user interface element according to the user preference.

4. The method of claim 2, wherein selecting the selected interaction component further comprises:
identifying, for a selected user interface element, an interaction criterion of the application for the user interface element;
determining, according to the interaction criterion, an interaction suitability of a first interaction component over a second interaction component; and
selecting the first interaction component for the selected user interface element according to the interaction suitability.

5. The method of claim 1, wherein:
the selected interaction component is accessible to the device through an auxiliary device; and
binding the selected interaction component to the user interface element further comprises: notifying the auxiliary device to bind the selected interaction component to the user interface element.

6. The method of claim 5, wherein:
a first interaction component is accessible to the device through a first auxiliary device;
a second interaction component is accessible to the device through a second auxiliary device;
the user interface further comprises a first user interface element and a second user interface element; and
selecting the selected interaction component further comprises:
selecting the first interaction component accessible through the first auxiliary device for the first user interface element; and
selecting the second interaction component accessible through the second auxiliary device for the second user interface element.

7. The method of claim 1, wherein:
a selected interaction component is accessible to the device through an auxiliary device; and
detecting the interaction component property of the interaction component further comprises: responsive to establishing a connection with the auxiliary device, profiling the auxiliary device to detect the interaction component property.

8. The method of claim 1, wherein executing the instructions further causes the device to, responsive to detecting an addition of a new interaction component:
compare the interaction component property of the new interaction component with the interaction component property of the selected interaction component; and
upon selecting the new interaction component over the selected interaction component for a selected user interface element:
unbind the selected interaction component from the selected user interface element; and
bind the new interaction component to the selected user interface element.

9. The method of claim 1, wherein executing the instructions further causes the device to, responsive to detecting an inaccessibility of the selected input component for a selected user interface element:
select a second interaction component for the user interface element; and
bind the second interaction component to the user interface element.

10. A device that presents a user interface for an application to a user, the device comprising:
an interaction component;
a processor; and
a memory storing instructions that, when executed by the processor, provide:
an interaction component property interface that detects an interaction component property of the interaction component;
an interaction criterion evaluator that identifies an interaction criterion of a user interaction of the application with the user through the user interface element;
a user interface adapter that, for respective user interface elements of the user interface of the application, chooses a presentation of the user interface element according to the interaction criterion of the user interaction and the interaction component property of the interaction component; and
a user interface presenter that:
generates the user interface incorporating the presentation of the respective user interface elements; and
presents the user interface of the application to the user through the interaction component.

11. The device of claim 10, wherein:
the interaction component property of the interaction component further comprises an interaction component type;
choosing the presentation of the user interface element further comprises: among at least two presentations of the user interface element that are respectively adapted for an interaction component type, choose the presentation of the user interface element that is associated with the interaction component type of the interaction component.

12. The device of claim 10, wherein:
the interaction criterion of the user interaction further comprises an interaction modality of the user interaction; and
choosing the presentation of the user interface element further comprises: among at least two presentations of the user interface element that are respectively adapted for an interaction modality, choose the presentation of the user interface element that is associated with the interaction modality of the user interaction.

13. The device of claim 10, wherein:
the interaction criterion of the user interaction further comprises a predicted attentiveness of the user to the user interface element during the user interaction; and
choosing the presentation of the user interface element further comprises: among at least two presentations of the user interface element that are respectively adapted for a content volume of content through the user interface element, choose a presentation that presents a content volume matching the predicted attentiveness of the user to the user interface element.

14. The device of claim 10, wherein executing the instructions further causes the device to, while the user interface element is associated with the interaction component, adapt an interaction component property of the interaction component to match the user interface element.

15. The device of claim 10, wherein:
the device further has access to a user interface element library comprising, for the respective user interface elements, at least two presentations of the user interface element that are respectively adapted for an interaction component property of an interaction component; and
the user interface generator further generates the user interface by, for the respective user interface elements, selecting, from the user interface element library, the presentation adapted for the interaction component property of the interaction component.

16. A memory device storing instructions that, when executed by a processor of a computing device, cause the computing device to present a user interface for an application through an interaction component, by:
detecting an interaction component property of the interaction component;
for respective user interface elements of the user interface of the application:
identifying an interaction criterion of a user interaction of the application with the user through the user interface element; and
choosing a presentation of the user interface element according to the interaction criterion of the user interaction and the interaction component property of the interaction component;
generating the user interface incorporating the presentation of the respective user interface elements; and
presenting the user interface of the application to the user through the interaction component.

17. The memory device of claim 16, wherein:
the interaction component property further comprises an information density of the user interaction with the application on the device; and
generating the user interface further comprises: arranging the user interface according to the information density of the user interaction.

18. The memory device of claim 16, wherein:
the device further has access to a user interface element library comprising, for the respective user interface elements, at least two presentations of the user interface element that are respectively adapted for an interaction criterion; and
generating the user interface further comprises: for the respective user interface elements, selecting, from the user interface element library, the presentation adapted for the interaction criterion of the user interaction of the application with the user through the user interface element.

19. The memory device of claim 16, wherein executing the instructions further causes the computing device to, while presenting the user interface to the user:
for the respective user interface elements, detect an interaction performance metric of the user interaction of the user with the user interface element; and
responsive to detecting an interaction performance metric for a selected user interface element that is below an interaction performance metric threshold:
choose a second presentation of the user interface element; and
substitute the second presentation of the user interface element in the user interface.

20. The memory device of claim 16, wherein executing the instructions further causes the computing device to, responsive to detecting an updated interaction criterion of the interaction criterion of the user interaction of the user with the user interface:
for the respective user interface elements:
choose a second presentation of the user interface element according to the updated interaction criterion; and
substitute the second presentation of the user interface element in the user interface.
